(19) United States
(12) Patent Application Publication
(10) Pub. No.: US 2012/0012437 A1
(43) Pub. Date: Jan. 19, 2012

(54) MONEY HANDLING MACHINE

(75) Inventor: Yasuhiro Matsumoto, Hyogo-ken (JP)

(73) Assignee: GLORY LTD., Hyogo-ken (JP)

(21) Appl. No.: 13/256,988

(22) PCT Filed: Mar. 11, 2010
(86) PCT No.: PCT/JP2010/054116

§ 371 Date: Sep. 16, 2011

(30) Foreign Application Priority Data
Mar. 19, 2009 (JP) 2009-068026
May 11, 2009 (JP) 2009-114416

(51) Int. Cl. G07F 9/10

(52) U.S. Cl. 194/342

(57) ABSTRACT

In a money handling machine (10), at least a recycling money storing and feeding unit (27, 34) is managed under first management authority and a money storing unit (40) is managed under second management authority different from the first management authority. When a command for performing a collecting process for allowing the money to be collected from the money storing unit (40) is inputted to a control unit (15), the control unit (15) controls money recycling units (20, 30) and the money storing unit (40), so as to perform a delivery process for delivering the money stored in the recycling money storing and feeding unit (27, 34) to the money storing unit (40), and then perform the collecting process.

### FIELD OF THE INVENTION

The present invention relates to a money handling machine configured to perform a depositing process for money, such as sales proceeds or the like, in a store or the like, a dispensing process for the money, such as change or the like, and a delivery process for delivering the money, such as the sales proceeds or the like, to a money collector (i.e. money collecting company). It is noted that the term “money” may be used herein for expressing either of banknotes and coins.

### BACKGROUND ART

In the past, the money handling machine, adapted for performing the depositing process for the money, such as the sales proceeds or the like, in the store or the like, dispensing process for the money, such as the change or the like, and delivery process for delivering the money, such as the sales proceeds or the like, to the money collector, has been known. The money handling machine of this type includes a money storing unit adapted for storing therein the money, and a money recycling unit adapted for temporarily storing therein the money taken into a casing from the exterior thereof as well as adapted for feeding the money stored in this money recycling unit or money taken into the casing from the exterior thereof to the money storing unit or returning such money to the exterior of the casing. In this case, the authority under which the money stored in the money recycling unit (money stored in an upper position) is managed is separated from the authority under which the money stored in the money storing unit (money stored in a lower position) is managed. Namely, the former management authority is given or provided on the side of the store where the depositing process or dispensing process is performed by the money handling machine, while the latter management authority is provided on the side of a certain person in charge of collecting the money of the money collector that performs a collecting process for collecting the banknotes or the like from the money handling machine. Therefore, each operation for the depositing process, dispensing process, delivery process and the like for the money stored in the upper position in the money handling machine or access to deposit/dispense information or money-amount data on the money stored in the upper position can be performed by only an operator authorized on the side of the store. Meanwhile, the collecting process for collecting the money stored in the lower position in the money handling machine can be performed by only the person in charge of collecting the money of the money collector. As used herein, the “money-amount data” means data, on the number for each denomination, total amount or amount of money for each denomination, of the money stored in the money handling machine. As the money handling machine of this type, a machine disclosed in, for example, Patent Document 1 (that will be described later), has been known.

Namely, the Patent Document 1 discloses a money deposit/dispense system that includes a deposit/dispense machine including a recycling and storing unit capable of storing therein cash as well as depositing and dispensing the cash, and a cassette storing unit adapted for storing therein the cash. More specifically, the recycling and storing unit is managed on the side of the store, while the cassette storing unit is managed on the side of the money collector in charge of collecting the sales proceeds. In this case, the cash put into the money deposit/dispense machine is stored in the recycling and storing unit. Then, as the cash is fed from the recycling and storing unit to the cassette storing unit, the cash is delivered to the money collector from the store. Further, in this case, the cash stored in the recycling and storing unit is managed as a change fund, while the cash stored in the cassette storing unit is managed as the sales proceeds.

In the money deposit/dispense system disclosed in the above Patent Document 1, when the operator, such as a clerk or the like, on the side of the store performs the depositing process for depositing the cash to the money deposit/dispense machine, the cash is stored in the recycling and storing unit. Meanwhile, when the operator performs the dispensing process for dispensing the cash from the money deposit/dispense machine, the cash is fed out to the exterior of the casing from the recycling and storing unit. Further, when the operator, such as the clerk or the like, on the side of the store performs the delivery process in this money deposit/dispense machine, the cash is fed from the recycling and storing unit to the cassette storing unit. Once the cash is stored in the cassette storing unit, this cash is regarded as the cash that has been delivered to the person in charge of collecting the money, such as the sales proceeds or the like, of the money collector. Generally, the delivery process in the money deposit/dispense machine is performed by a person, such as a manager or the like of the store, having certain authority provided on the side of the store. Then, when the person in charge of collecting the money of the money collector inputs a command for performing the collecting process for the cash to the money deposit/dispense machine, each cassette located in the cassette storing unit can be taken out. Thus, the person in charge of collecting the money can collect the cash.

The aforementioned collecting process is performed for taking out the cash from the money deposit/dispense machine under the management authority provided on the side of the money collector. Therefore, the operator authorized on the side of the store cannot perform this collecting process. Meanwhile, the delivery process is performed for delivering the cash under the management authority given on the side of the store. Therefore, the person in charge of collecting the money of the money collector cannot perform this delivery process. Namely, depending on a section, position, authority or the like of the operator, there is a restriction in the process that can be performed.

In general, the work for collecting the cash from the money deposit/dispense machine is performed, e.g., once in every three days, by the person in charge of collecting the money of the money collector, in accordance with a predetermined schedule. However, if at least one of a banknote cassette and a coin cassette in the cassette storing unit is full up with the cash delivered during a period of time between one collecting work and the next collecting work in the predetermined schedule, it becomes necessary to make a request for a special cash collecting work to the person in charge of collecting the money of the money collector. However, such a special cash collecting work is charged, and thus requires an additional fee. Therefore, it is desirable for some stores to possibly suppress the occurrence of such a special cash collecting work.

Meanwhile, for some money collectors, the occurrence of such a special cash collecting work is not desired. More specifically, the cash collecting work is usually performed by the person in charge of collecting the money of the money collector, in accordance with the predetermined schedule, including the order, time and the like of the work, for a plurality of customers or the like. Therefore, if the special cash collecting work occurs, it is necessary to alter the schedule. Further, if the place where the special cash collecting work occurs is considerably away from the place where the cash collecting work is scheduled on that day, it is sometimes necessary to send another person than the person scheduled, for such a special cash collecting work. This requires additional time and cost, and thus leads to rather deterioration of the working efficiency. Therefore, even though the additional fee can be obtained, the occurrence of the special cash collecting work is not desired or unwanted for some money collectors.

Patent Document 1: JP2002-312833A

### DISCLOSURE OF THE INVENTION

In general, the frequency of occurrence of the special cash collecting work can be lowered, by collecting the cash, as much as possible, upon such a periodic cash collecting work as described above. For instance, if the delivery process for the cash can be performed just before the collecting process for the cash and surplus cash remaining in the recycling and storing unit can be transferred to the cassette storing unit, the frequency of the occurrence of the special cash collecting work can be substantially lowered. To this end, it is necessary for the operator, such as the manager or the like, having certain management authority provided on the side of the store to perform the delivery process for the cash, each time the cash collecting work is performed by the person in charge of collecting the money of the money collector. This is because the person in charge of collecting the money of the money collector is not authorized to perform the delivery process for the cash.

However, since the cash collecting work is usually performed, during the day time, by the person in charge of collecting the money of the money collector, the operator, such as the manager or the like, having the management authority provided on the side of the store cannot always correspond to such a cash correcting work, because of another business or the like. Further, the store, in which the operator, such as the manager or the like, having the management authority is not always stationed, cannot correspond to such a cash collecting work.

The present invention was made in light of the above circumstances. Therefore, it is an object of this invention to provide the money handling machine, which is adapted for performing the delivery process for the money and then performing the collecting process for the money, when a command for performing the collecting process for allowing the money to be collected from the money storing unit is inputted to a control unit, and thus enables the money to be collected, as much as possible, from the money storing unit, by only the operation of the money handling machine performed by one person having second management authority, such as the person in charge of collecting the money of the money collector, without any need for the operation of the money handling machine performed by another person having first management authority, such as the clerk or the like in the store, thereby to substantially lower the frequency of occurrence of the money collecting work.

The money handling machine of the present invention is adapted for handling the money and includes: a casing; an inlet configured to allow the money to be put into the casing from the exterior thereof; a transport unit connected with the inlet and configured to transport the money; a money storing unit connected with the transport unit and configured to store therein the transported money; a recycling money storing and feeding unit connected with the transport unit and configured to store therein the transported money and feed out the stored money to the transport unit; and a control unit configured to control the transport unit, the money storing unit and the recycling money storing and feeding unit, at least the recycling money storing and feeding unit is managed under a first management authority and the money storing unit is managed under a second management authority different from the first management authority, and when a command for performing a collecting process for allowing the money to be collected from the money storing unit is inputted to the control unit, the control unit controls the money storing unit, the transport unit and the recycling money storing and feeding unit, so as to perform a delivery process for delivering the money stored in the recycling money storing and feeding unit to the money storing unit, and then perform the collecting process.

In this money handling machine of the present invention, the money storing unit is managed under the second management authority different from the first management authority. Therefore, the collecting process for collecting the money stored in the money storing unit therefrom is performed by the person in charge of collecting the money of the money collector having the second management authority. Further, in this money handling machine, when the command for performing the collecting process is inputted to the control unit, the delivery process for the money is first performed, and then the collecting process for the money is performed. In this case, since the delivery process for the money is first performed automatically when the command for performing the collecting process for the money is inputted to the control unit, the delivery process for the money can be performed, only by the operation of the money handling machine performed by the person in charge of collecting the money of the money collector having the second management authority, without any need for the operation of the money handling machine performed by another person, such as the clerk or the like of the store, having the first management authority. Then, since the delivery process for the money can be automatically performed before the collecting process for the money is performed, the amount of the money stored in the money storing unit, at a point time just before the collecting process for the money is performed, can be substantially increased. This can enable the money to be collected from the money storing unit, as much as possible. As such, the frequency of occurrence of the money collecting work can be significantly reduced.

In the money handling machine of the present invention, it is preferable that the amount of the money to be delivered is set by the control unit, the amount of the money to be delivered being the amount of money or the number of money by denomination to be delivered from the recycling money storing and feeding unit to the money storing unit during the delivery process.

In this case, the control unit may calculate the amount of the money to be delivered, based on the amount of the money to be left, the amount of the money to be left being the amount of the money or the number of the money by denomination to be left in the recycling money storing and feeding unit after the delivery process is performed.

The amount of the money to be left may be a given value that is set in advance.

Alternatively, the amount of the money to be left may be calculated, based on the amount of the money stored in the recycling money storing and feeding unit before the delivery process is performed

The amount of the money to be delivered may be a given value that is set in advance.

The amount of the money to be delivered may be calculated, based on the amount of money or the number of the money by denomination taken into the casing from the exterior thereof after the previous delivery process is performed and before the current delivery process is performed.

The amount of the money to be delivered may be calculated, based on the amount of the money stored in the recycling money storing and feeding unit before the delivery process is performed.

The amount of the money to be delivered may be calculated, based on the capacity of the money storing unit to store the money.

The amount of the money to be delivered may be calculated, based on a denomination that is designated in advance and the money amount of this denomination.

The amount of the money to be delivered may be set, with the large denomination having priority.

When the money storing unit is full up with the money during the delivery process, the control unit may terminate the delivery process and performs the collecting process.

When the money storing unit is full up with the money during the delivery process, the control unit may suspend the delivery process and performs the collecting process, and then performs again the delivery process after the collecting process.

### BRIEF DESCRIPTION OF THE DRAWINGS

FIG. 1A is a block diagram showing one exemplary construction of a money handling system related to the present invention.

FIG. 1B is a block diagram showing another construction of the money handling system related to the present invention.

FIG. 2A is a perspective view showing the money handling machine provided in the money handling system shown in FIG. 1A or 1B.

FIG. 2B is a perspective view showing a state in which the money storing unit is pulled out from the casing of the money handling machine shown in FIG. 2A.

FIG. 3A is a diagram for schematically illustrating the construction of a banknote handling machine provided in the money handling machine shown in FIG. 2A.

FIG. 3B is a diagram for schematically illustrating the construction of a coin handling machine provided in the money handling machine shown in FIG. 2A.

FIG. 4 is a block diagram for illustrating a control system provided to the money handling machine shown in FIG. 2A.

FIG. 5 is a flow chart showing one example of the operation for the money collecting work related to a first embodiment of the present invention and performed in the money handling machine shown in FIG. 2A.

FIG. 6 is a diagram for illustrating display contents displayed on a display unit of the money handling machine shown in FIG. 2A.

FIG. 7 is a diagram for illustrating management for the banknotes or coins stored in the recycling banknote storing units or recycling coin storing units, under the control of the control unit of the money handling machine shown in FIG. 2A, in which FIG. 7(a) shows one case in which the money of the store (or store money) to be managed under the management authority provided on the side of the store is managed separately from the sales proceeds to be managed under the management authority provided to another person than those related to store, and FIG. 7(b) shows another case in which the store money to be managed under the management authority provided on the side of the store is managed separately from the total amount of money (the total amount of the stored money) of the banknotes or coins stored in the recycling banknote storing units or recycling coin storing units.

FIG. 8 is a diagram for illustrating the display contents displayed on the display unit of the money handling machine related to a second embodiment of the present invention.

FIG. 9 is a flow chart showing the operation of the money handling machine related to the second embodiment of the present invention.

FIG. 10 is a flow chart further showing the operation of the money handling machine related to the second embodiment of the present invention.

### DETAILED DESCRIPTION OF THE INVENTION

### First Embodiment

Hereinafter, the money handling machine related to the first embodiment of the present invention will be described with reference to the drawings. The money handling machine related to this embodiment includes the money storing unit to be managed under the management authority provided on the side of the person in charge of collecting the money, and the money recycling unit to be managed under the management authority provided on the side of the store. The money storing unit and money recycling unit are housed in one casing.

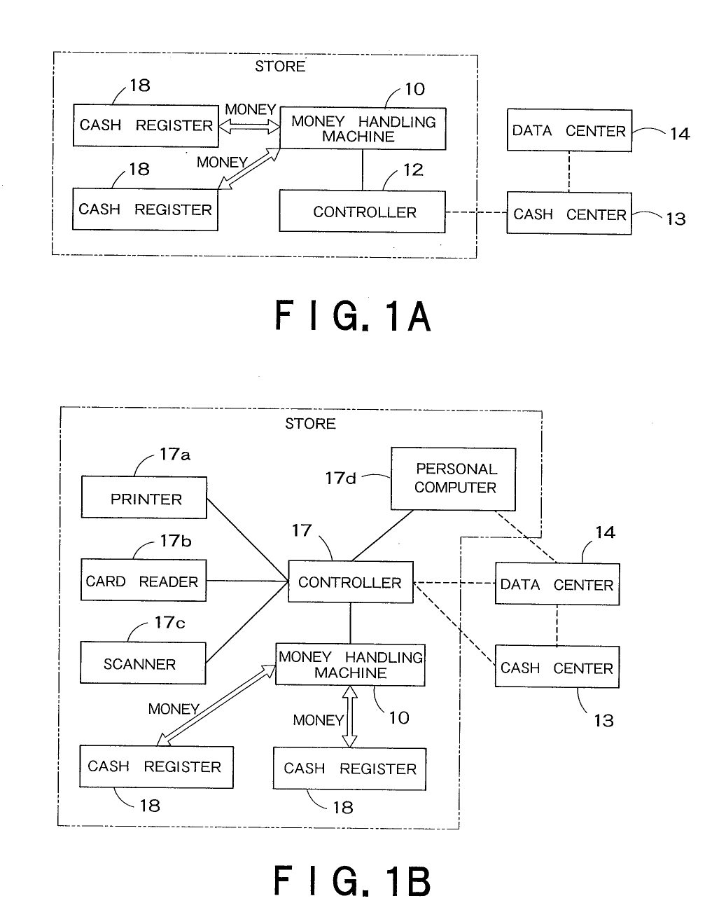

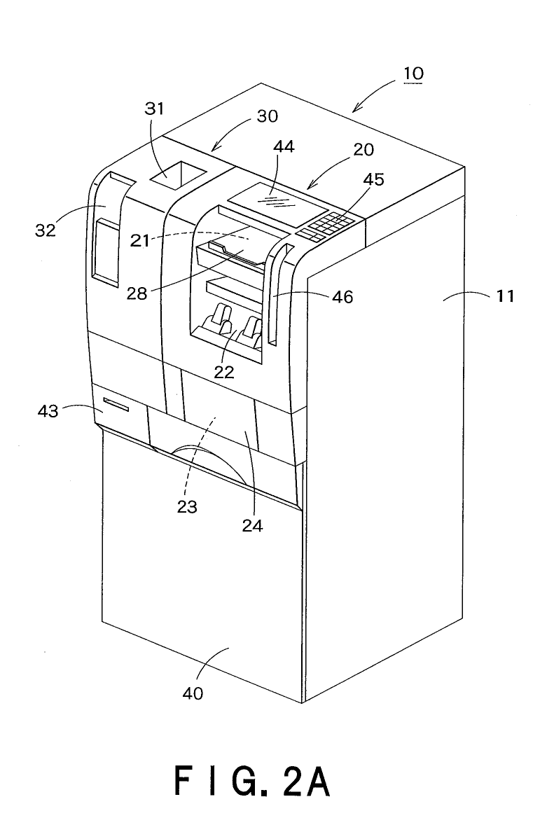

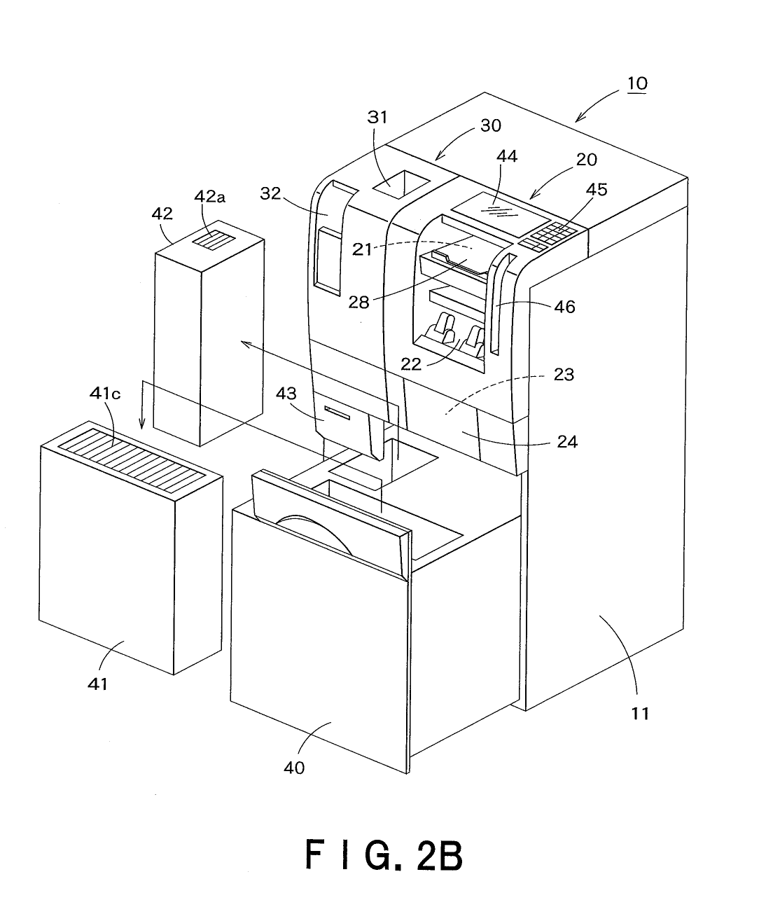

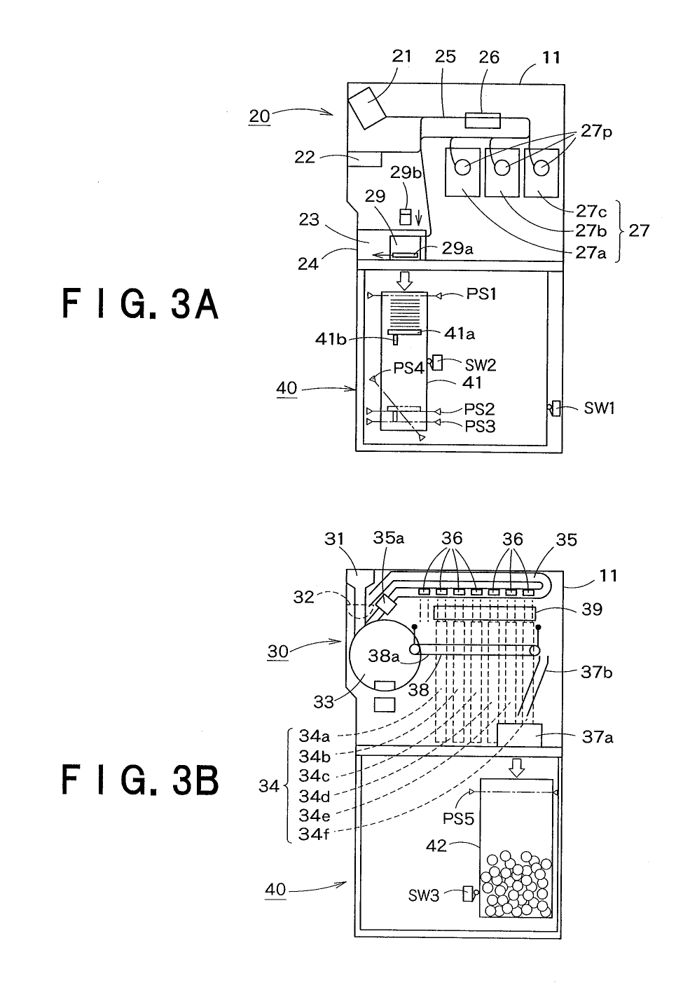

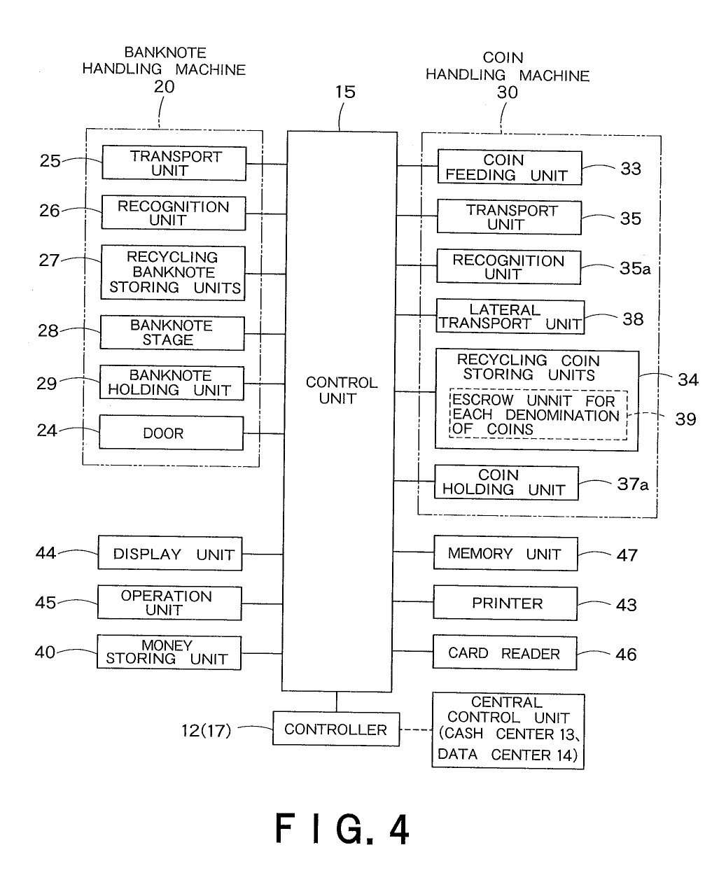

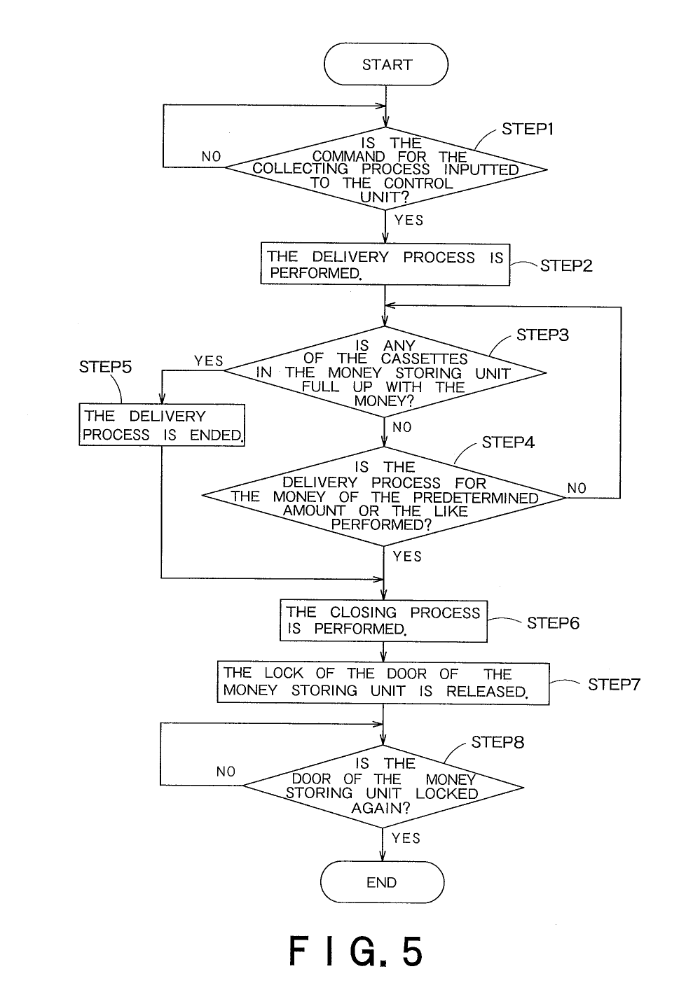

The money handling machine related to this embodiment can serve to perform a refilling process, a depositing process, a dispensing process, a delivery process, a mass delivery process, an exchange from large denomination to small denomination process, an exchange from small denomination to large denomination process, a reconciliation process, a counting process, a closing process, a collecting process (hereinafter, also referred to as a “collection by staff (collection by staff of an armourd car company) process”) and the like. FIGS. 1 through 6 are respectively provided for illustrating the construction of the money handling system of the present invention. Of these drawings, the block diagram of FIG. 1A illustrates one exemplary construction of the money handling system of the present invention, and the block diagram of FIG. 1B illustrates another construction of the money handling system of the present invention. The perspective view of FIG. 2A is provided for illustrating the money handling machine in the money handling system shown in FIG. 1A or 1B, and the perspective view of FIG. 2B is provided for illustrating one state in which the money storing unit is pulled out from the casing of the money handling machine shown in FIG. 2A. FIG. 3A schematically illustrates the construction of the banknote handling machine provided in the money handling machine shown in FIG. 2A, and FIG. 3B is schematically illustrates the construction of the coin handling machine provided in the money handling machine shown in FIG. 2A. Further, the block diagram of FIG. 4 is provided for illustrating the control system for the money handling machine shown in FIG. 2A. In addition, the flow chart of FIG. 5 is provided for illustrating one example of the operation for the money collecting work related to the first embodiment of the present invention and performed in the money handling machine shown in FIG. 2A, and FIG. 6 is provided for illustrating the display contents on the display unit of the money handling machine shown in FIG. 2A.

As shown in FIG. 1A, the money handing system of this embodiment includes a money handling machine 10 installed in the store, and a cash center 13 and a data center 14, respectively isolated from the money handling machine 10 and located outside the store. A central control unit is installed for each of the cash center 13 and data center 14. In the following description, each of the cash center 13 and data center 14 may imply the central control unit. A controller 12 is provided to the money handling machine 10, and this controller 12 is connected, for wired or wireless communication, with the cash center 13, such that a signal can be transmitted and received between the controller 12 and the cash center 13. With this configuration, the money handling machine 10 can be remotely controlled from the cash center 13 via the controller 12. In this case, the controller 12 is composed of a communication control device or terminal connected with the money handling machine 10, via a LAN or the like, or otherwise composed of a communication unit or the like incorporated in the money handling machine 10.

Further, as shown in FIG. 1A, the cash center 13 and data center 14 are connected, for wired or wireless communication, with each other, such that various data can be transmitted and received between the cash center 13 and data center 14. Therefore, information on the process condition of the money, such as the banknotes, coins or the like, in the money handling machine 10, sent from the money handling machine 10 to the cash center 13 via the controller 12 can also be transmitted to the data center 14. In the present invention, the central control unit is provided for each of the cash center 13 and data center 14. However, the arrangement of the central control unit is not limited to this example. For instance, the central control unit may be provided to only the cash center 13, or otherwise may be provided to only the data center 14.

Further, as shown in FIG. 1A, one or more cash registers 18 are provided in one store. Although FIG. 1A shows one example in which two cash registers 18 are provided in the store, three or more cash registers 18 may be provided to the store, or otherwise only one cash register 18 may be provided to the store. In any case, each cash register 18 is managed under the management authority provided on the side of the store (i.e., the first management authority), and is operated by the clerk or the like of the store. Therefore, each cash register 18 is refilled with the money, as the change fund or the like, dispensed from the money handling machine 10 by the clerk or the like.

The construction of the money handling system of this embodiment is not limited to the example as shown in FIG. 1A, but may also be constructed as shown in FIG. 1B. Although the money handling system shown in FIG. 1B has substantially the same construction as the money handling system shown in FIG. 1A, in that the system in FIG. 1B includes the cash center 13 and data center 14, respectively isolated from the money handling machine 10 and located outside relative to the store, a controller 17 shown in FIG. 1B and provided to the money handling machine 10 has a function of higher expandability.

The controller 17 is connected, for wired or wireless communication, with the cash center 13 and data center 14, such that the signal can be transmitted and received between this controller 17 and the cash center 13 and data center 14.

Further, for the controller 17 of the money handling system shown in FIG. 1B, additional functions, i.e., a printer 17a, a card reader 17b, a scanner 17c, can be provided, respectively. In this case, the printer 17a is provided for printing information concerning the process condition or the like of the money, such as the banknotes, coins or the like, in the money handling machine 10. The card reader 17b can be connected with the controller 17, in addition to a card reader provided to the money handling machine 10, and is provided for reading ID information of an ID card carried by each operator. Namely, this card reader 17b is used for identifying each operator, by reading a signal indicative of the ID information of the operator inputted to the controller 17. The scanner 17c is provided for imaging a serial number, bar code or the like of each banknote. Further, in this case, the controller 17 can also serve as a router.

In addition, a personal computer 17d of the operator can also be connected with the controller 17. In this case, the operation of the money handling machine 10 can be performed by the personal computer 17d connected with the controller 17. Further, this personal computer 17d can also be provided to transmit and receive the signal relative to the data center 14.

Similar to the money handling system shown in FIG. 1A, the money handling system shown in FIG. 1B also includes one or more cash registers 18 provided in one store.

Next, referring to FIGS. 2 through 4, the construction of the money handling system 10 shown in FIG. 1A or 1B will be described in more detail.

As shown in FIG. 2A, the money handling machine 10 includes a casing 11 having a substantially rectangular parallelepiped shape. When the money handling machine 10 is seen from the forward, a banknote handling machine 20 is located in an upper right portion of the casing 11, and a coin handling machine 30 is located in an upper left portion of the casing 11. Further, in the casing 11 of the money handling machine 10, a money storing unit 40 adapted for storing therein the coins and banknotes is provided below the banknote handling machine 20 and coin handling machine 30. In this money handling machine 10, the banknote handling machine 20 and coin handling machine 30 are respectively managed under the management authority provided on the side of the store (or first management authority), while the money storing unit 40 is managed under the management authority provided on the side of the person in charge of collecting the money (or second management authority).

Hereinafter, each component of the banknote handling machine 20, coin handling machine 30 and money storing unit 40 will be described.

First, referring to FIGS. 2A and 3A, the construction of the banknote handling machine 20 will be described. As shown in FIGS. 2A and 3A, the banknote handling machine 20 includes a banknote inlet 21 provided for allowing the banknotes to be taken into the banknote handling machine 20, a banknote reject slot 22 provided for rejecting counterfeit banknotes, unrecognizable banknotes or the like, among the banknotes taken in the banknote handling machine 20, and a banknote return slot 23 provided for returning the banknotes, not respectively stored in the money storing unit 40, among the banknotes taken in the banknote handling machine 20, to the exterior of the banknote handling machine 20. Further, as shown in FIG. 3A, a transport unit 25 adapted for transporting the banknotes, respectively put in the banknote handling machine 20 via the banknote inlet 21, is provided in the banknote handling machine 20.

The banknote inlet 21 is configured for allowing one banknote or one batch of the plurality of banknotes to be collectively inserted in a long-edge first orientation. As shown in FIG. 2A, a banknote stage 28 is provided to the banknote inlet 21. When the banknote stage 28 is in a waiting state, this stage 28 takes an elevated position, in which the operator cannot insert the banknotes through the banknote inlet 21. Meanwhile, when the banknotes are handled, the banknote stage 28 is lowered, such that the operator can insert the banknotes through the banknote inlet 21. Further, as shown in FIG. 3A, the banknote inlet 21 is connected with the transport unit 25, such that one banknote or one batch of the plurality of banknotes inserted through the banknote inlet 21 can be transported, one by one, by the transport unit 25. In addition, the banknote reject slot 22 is connected with the transport unit 25, as shown in FIG. 3A, such that the banknotes respectively recognized as the banknotes to be rejected or banknotes that cannot be recognized, by the recognition unit 26, among the banknotes taken in the banknote handling machine 20 via the banknote inlet 21, can be fed to this reject slot 22 from the transport unit 25. The operator can take out the banknotes fed to the banknote reject slot 22.

Further, as shown in FIG. 3A, a banknote holding unit 29 connected with the transport unit 25 is provided to the banknote return slot 23. This banknote holding unit 29 is provided to receive and hold the banknotes respectively fed from the transport unit 25. In addition, a door 24 that can be optionally opened and closed is provided to the banknote return slot 23. In the case of returning the banknotes held in the banknote holding unit 29, a wall face of the banknote holding unit 29 located on the front face side of the machine is opened to allow the operator to take out the banknotes through the opened door 24. In this case, when the banknotes are respectively in the condition that can allow the banknotes to be taken out, the door 24 will be automatically opened. In some cases, as will be described later, the banknotes held in the banknote holding unit 29 will be fed to a banknote storing cassette 41 (that will be described later) located in the money storing unit 40, in place of being taken out from the banknote return slot 23 by the operator.

The transport unit 25 can serve to transport the banknotes, one by one, in the banknote handling machine 20. More specifically, in this transport unit 25, each banknote is transported along a transport path, while being grasped or held between a pair of belts. Further, as shown in FIG. 3A, the transport path provided in the transport unit 25 is bifurcated at various points, and diverters (not shown) are provided, respectively, at the same points as the respective points at which the transport path is bifurcated. Each diverter is composed of, for example, a bifurcating nail, and is controlled by a control unit 15 that will be described later. In this case, a recognition unit 26 is provided along the transport unit 25. This recognition unit 26 is adapted for recognizing each banknote transported by the transport unit 25, one by one. More specifically, this recognition unit 26 can serve to recognize the denomination, authentication, fitness and the like of each banknote transported by the transport unit 25. The recognition result on each banknote recognized by the recognition unit 26 is sent to the control unit 15 that will be described later.

A plurality of (e.g., three) recycling banknote storing units 27 are arranged, in parallel to one another, in the banknote handling machine 20. In general, each of the recycling banknote storing units 27a to 27c is provided for temporarily storing therein the banknotes, for each denomination. As shown in FIG. 3A, each recycling banknote storing unit 27 has a drum 27p that can be optionally rotated in both of the forward and backward directions. In this case, a pair of tapes are wound around each drum 27p. Namely, each banknote fed to one recycling banknote storing unit 27 from the transport unit 25 is wound and stored around the drum 27p, one by one, together with the pair of tapes, while being grasped or held between the tapes. In this case, when the drum 27p is rotated in the reverse direction, each banknote wound around the drum 27p can be fed out, one by one, to the transport unit 25. It should be noted that each recycling banknote storing unit 27 is not limited to this construction including the drum 27p and pair of tapes, in which the pair of tapes are wound around the drum 27p, with each banknote being grasped or held between the pair of tapes. For instance, each recycling banknote storing unit 27 may be a stacker-type storing unit.

The banknote holding unit 29 is provided to the banknote return slot 23, as described above, and is connected with the transport unit 25, as shown in FIG. 3A. This banknote holding unit 29 serves to receive the banknotes put into the banknote inlet 21 and then transported to this unit 29 by the transport unit 25, or serves to receive the banknotes stored in each recycling banknote storing unit 27 and then transported to this unit 29 by the transport unit 25. In this case, the banknotes respectively fed from the transport unit 25 can be held or escrowed in large numbers, in a batch form. As shown in FIG. 3A, an escrow plate 29a and a holding member 29b are provided to the banknote holding unit 29. In this case, when the banknotes are returned from the banknote holding unit 29, the wall face of this unit 29 located on the front face side of the machine is opened as described above, such that the operator can take out the banknotes through the door 24. In this case, when the banknotes are respectively in the condition that can allow the banknotes to be taken out, the door 24 will be automatically opened. Meanwhile, when the banknotes are held in the holding unit 29, the banknotes are once placed on the escrow plate 29a. Further, when the banknotes held in the holding unit 29 are stored in the banknote storing cassette 41, a stage 41a provided in the banknote storage cassette 41 is first moved to receive the banknotes placed on the escrow plate 29a of the banknote holding unit 29. Thereafter, the escrow plate 29a is evacuated, in a direction designated by an arrow depicted in FIG. 3A, to place the banknotes on the stage 41a. In this way, the banknotes are transferred onto the stage 41a, and then the stage 41a is lowered from the banknote holding unit 29 toward the banknote storing cassette 41. Then, the banknotes placed on the stage 41a is pressed from above by the holding member 29b, and thus stored in the banknote storing cassette 41

Next, referring to FIGS. 2A and 3B, the construction of the coin handling machine 30 will be described. As shown in FIGS. 2A and 3B, the coin handling machine 30 includes a coin inlet 31 provided for allowing the coins to be taken into the coin handling machine 30, and a coin return slot 32 provided for rejecting unrecognizable coins or the like recognized by a recognition unit 35a, among the coins taken in the coin handling machine 30, and returning the coins, not respectively stored in the money storing unit 40, among the coins taken in the coin handling machine 30, to the exterior of the coin handling machine 30. Further, as shown in FIG. 3B, a transport unit 35 adapted for transporting the coins, respectively taken in the coin handling machine 30 via the coin inlet 31, is provided in the coin handling machine 30.

The coin inlet 31 is configured for allowing one or more coins to be collectively put into this inlet 31. The coins put into the coin inlet 31 are respectively fed into the coin handling machine 30. The coin return slot 32 is connected with a downstream-side end of the transport unit 35, and is configured for allowing the coins fed from the transport unit 35 to be accumulated in this slot 32. Thus, the operator can take out the coins accumulated in the coin return slot 32. In this case, as described above, the unrecognizable coins or the like recognized by the recognition unit 35a that will be described later, among the coins taken in the coin handling machine 30, and the coins, not respectively stored in the money storing unit 40, among the coins taken in the coin handling machine 30, are respectively fed to the coin return slot 32. Namely, such coins are returned to the exterior of the coin handling machine 30 via the coin return slot 32.

As shown in FIG. 3B, a coin feeding unit 33 is provided in the coin handling machine 30. The coin feeding unit 33 is provided to be in communication with the coin inlet 31, and serves to temporarily accumulate therein the coins put into the coin handling machine 30 by the operator via the coin inlet 31, and then feed out such accumulated coins toward the transport unit 35.

The transport unit 35 serves to transport the coins, one by one, successively, in the coin handling machine 30. As shown in FIG. 3B, an upstream-side end and the downstream-side end of the transport unit 35 are respectively connected with the coin feeding unit 33 and coin return slot 32. Further, the recognition unit 35a is provided to the transport unit 35. This recognition unit 35a is adapted for recognizing the coins transported by the transport unit 35, one by one. In this case, the recognition unit 35a serves to recognize the denomination, authentication and the like of each coin transported by the transport unit 35. The recognition result on each coin recognized by the recognition unit 35a is sent to the control unit 15 that will be described later.

A plurality of (e.g., six) recycling coin storing units 34 are arranged, in parallel to one another, in the coin handling machine 30. Each recycling coin storing unit 34 is of a cylindrical shape and configured for taking in and taking out the coins from the top of the storing unit. Further, each recycling coin storing unit 34 extends in the vertical direction. In general, each of the recycling coin storing units 34a to 34f is provided for temporarily storing therein the coins, for each denomination, in a stacked condition.

As shown in FIG. 3B, seven sorting holes 36 are arranged in the middle of the transport unit 35, with a given interval, in succession, from the coin feeding unit 33 toward the downstream side. The sorting hole 36 (or overflow sorting hole 36) positioned on the most upstream side, among the seven sorting holes 36, is provided for feeding the coins, directly, to a lateral transport unit 38 that will be described later, from the transport unit 35. More specifically, the sorting hole 36 positioned on the most upstream side serves to feed the coins onto the lateral transport unit 38, when the recognition result of the coins respectively recognized by the recognition unit 35a satisfies a predetermined condition (e.g., when a certain recycling coin storing unit 34 corresponding to the denomination of the coins respectively recognized by the recognition unit 35a is full up with the coins). The second to seventh sorting holes 36 arranged from the upstream side are respectively corresponding to the recycling coin storing units 34a to 34f.

As shown in FIG. 3B, an escrow unit 39 for each denomination of the coins, which is adapted for escrowing or temporarily holding therein the coins, is provided to an upper portion of each recycling coin storing unit 34 extending in the vertical direction. With this configuration, the coins falling down from the transport unit 35, via each sorting hole 36, except for the sorting hole 36 positioned on the most upstream side among the seven sorting holes 36, will be escrowed in the escrow unit 39 for each denomination of the coins. Thereafter, the coins escrowed in this escrow unit 39 for each denomination of the coins are stored in each corresponding recycling coin storing unit 34. In this case, the escrow unit 39 for each denomination of the coins includes a dispensing member, such that the coins escrowed in this escrow unit 39 can also be dispensed by the dispensing member onto the lateral transport unit 38 that will be described later. Meanwhile, in the case the coins stored in each recycling coin storing unit 34 is taken out from this recycling coin storing unit 34, a stage (not shown) provided to a lower portion of the recycling coin storing unit 34 is first lifted upward. Thus, the coins placed on this stage will be fed to the escrow unit 39 for each denomination of the coins, and then dispensed onto the lateral transport unit 38 by the dispensing member of the escrow unit 39 for each denomination of the coins.

As shown in FIG. 3B, a coin holding unit 37a is provided in the coin handling machine 30, with a chute 37b being located above the coin holding unit 37a. With this configuration, the coins fed to a top portion of the chute 37b from the lateral transport unit 38 that will be described later are respectively fed to the coin holding unit 37a through the chute 37b. Then, the coins temporarily held in the coin holding unit 37a will be fed to a coin storing cassette 42 (that will be described later) located in the money storing unit 40.

Further, as shown in FIG. 3B, the lateral transport unit 38 is provided in the coin handling machine 30. This lateral transport unit 38 is located in the vicinity of the recycling coin storing units 34 respectively extending in the vertical direction, and includes a circular belt 38a extending in a substantially horizontal direction. The circular belt 38a can be circulated or rotated in both of the clockwise and anticlockwise directions in FIG. 3B. One end of the lateral transport unit 38 is positioned in the coin feeding unit 33, while the other end of the lateral transport unit 38 is positioned in the vicinity of the top portion of the chute 37b. In this case, when the circular belt 38a is rotated in the anticlockwise direction in FIG. 3B, the coins placed on the lateral transport unit 38 will be fed to the coin feeding unit 33. Meanwhile, when the circular belt 38a is rotated in the clockwise direction in FIG. 3B, the coins placed on the lateral transport unit 38 will be fed to the chute 37b, and finally held in the coin holding unit 37a.

Now, referring to FIGS. 2A and 2B, the construction of the money storing unit 40 will be described. As shown in FIG. 2A, the money storing unit 40 is provided to a lower portion of the casing 11 of the money handling machine 10. Further, as shown in FIGS. 3A and 3B, the money storing unit 40 includes the banknote storing cassette 41 provided for storing therein the banknotes and the coin storing cassette 42 provided for storing therein the coins. More specifically, the banknote storing cassette 41 is provided for storing therein the banknotes held in the banknote holding unit 29 of the banknote handling machine 20 (see FIG. 3A). Meanwhile, the coin storing cassette 42 is provided for storing therein the coins held in the coin holding unit 37a of the coin handling machine 30 (see FIG. 3B). In this state, when the money storing unit 40 is pulled out forward from the casing 11 by the person in charge of collecting the money, such as the sales proceeds or the like, of the money collector, as shown in FIG. 2B, each cassette 41, 42 itself can be collected from the money storing unit 40 by the person in charge of collecting the money.

Further, as shown in FIG. 2B, a shutter 41c is provided to a top face of the banknote storing cassette 41. This shutter 41c is automatically opened by a drive unit (not shown), when a certain process is performed, after the banknote storing cassette 41 is stored in the money storing unit 40 and then the money storing unit 40 is set in the casing 11. For instance, when the delivery process for the banknotes is performed, the shutter 41c is opened, so that the banknotes can be fed from the banknote holding unit 29 to the banknote storing cassette 41. Thereafter, once the delivery process is ended, the shutter 41c is closed. Further, when the money storing unit 40 is pulled out from the casing 11, the shutter 41c is definitely closed. In addition, the banknote storing cassette 41 has a door (not shown) having a lock provided thereto. Namely, this door can be opened by only a certain person authorized to have a key for the lock.

As shown in FIG. 3A, a money-storing-unit-setting detection switch SW1 is provided to the money storing unit 40, such that whether or not the money storing unit 40 is set in the casing 11 can be detected by this money-storing-unit-setting detection switch SW1. Further, a banknote-storing-cassette-setting detection switch SW2 is provided to the money storing unit 40, such that whether or not the banknote storing cassette 41 is set in the money storing unit 40 can be detected by this banknote-storing-cassette-setting detection switch SW2.

A light shielding plate 41b extending downward is attached to a bottom face of the stage 41a of the banknote storing cassette 41. Further, a stage stop sensor PS1, a banknote full detection sensor PS2, a mechanical end sensor PS3 and a residue detection sensor PS4 are respectively provided to the money storing unit 40 in the vicinity of the banknote storing cassette 41. Each of such sensors PS1, PS2, PS3 and PS4 is composed of an optical sensor. In this case, when the delivery process for the banknotes is performed, the banknotes are first placed on the stage 41a, and then the stage 41a is lowered, from a light shielded state of the stage stop sensor PS1, in which the light emitted toward the stage stop sensor PS1 is shielded by the banknotes placed on the stage 41a, up to a light transmitted state of the stage stop sensor PS1, in which the light is transmitted to the sensor PS1. Once the stage stop sensor PS1 is changed from the light shielded state to the light transmitted state, the stage 41a that has been so far lowered is stopped. Thereafter, when the banknote full detection sensor PS2 is changed from the light transmitted state into the light shielded state by the light shielding plate 41b attached to the stage 41a, the condition that the banknote storing cassette 41 is full up with the banknotes is detected. When the stage 41a is lowered and the light shielding plate 41b is detected by the mechanical end sensor PS3, the stage 41a will be compulsorily stopped. Further, in the case the stage 41a is lowered and the banknote full detection sensor PS2 is changed from the light transmitted state into the light shielded state by the light shielding plate 41b, if the residue detection sensor PS4 is in the light transmitted state, “CASSETTE EMPTY (i.e., there is no banknote remaining on the stage 41a)” is detected. Meanwhile, in the case the stage 41a is lowered and the banknote full detection sensor PS2 is changed from the light transmitted state into the light shielded state by the light shielding plate 41b, if some banknotes are remaining on the stage 41a, the residue detection sensor PS4 is changed into the light shielded state by such banknotes remaining on the stage 41a.

Further, as shown in FIG. 2B, another shutter 42a is provided to a top face of the coin storing cassette 42. This shutter 42a is opened, when the money storing unit 40 is set in the casing 11, with the coin storing cassette 42 being stored in this money storing unit 40. For instance, when the delivery process for the coins is performed, this shutter 42a is opened, so that the coins can be fed from the coin holding unit 37a to the coin storing cassette 42. Meanwhile, when the money storing unit 40 is pulled out from the casing 11, the shutter 42a is closed. Further, the coin storing cassette 42 has a door (not shown) having a suitable lock provided thereto. Namely, this door can be opened by only a certain person authorized to have the key for the lock.

As shown in FIG. 3A, a coin-storing-cassette-setting detection switch SW3 is provided to the money storing unit 40, such that whether or not the coin storing cassette 42 is set in the money storing unit 40 can be detected by this coin-storing-cassette-setting detection switch SW3. Further, a coin full detection sensor PS5 composed of the optical sensor is provided to the money storing unit 40 in the vicinity of the coin storing cassette 42. Namely, upon the delivery process for the coins, when the coin storing cassette 42 is full up with the coins, and thus the coin full detection sensor PS5 is changed from the light transmitted state into the light shielded state by the coins stored in the coin storing cassette 42, the condition that the coin storing cassette 42 is full up with the coins is detected.

As described above, the banknote handling machine 20 and coin handling machine 30 are managed under the management authority provided on the side of the store (or first management authority). Meanwhile, the money storing unit 40 is managed under the management authority provided on the side of the person in charge of collecting the money (or second management authority). Therefore, the various processes for the banknotes or coins, respectively stored in the recycling banknote storing units 27 provided in the banknote handling machine 20 or recycling coin storing units 34 provided in the coin handling machine 30, and the access to the deposit/dispense information or money-amount data on such banknotes and coins can be performed by only the operator authorized on the side of the store. Meanwhile, the collecting process for the banknotes or coins stored in the money storing unit 40 can be performed by only the person in charge of collecting the money of the money collector.

Next, other various mechanisms respectively provided in the money handling machine 10 will be described. As shown in FIG. 2A, an operation unit 45 for allowing the operator to input various commands to the control unit 15 (that will be described later) of the money handling machine 10, and a display unit 44 for displaying process contents concerning the money in the money handling machine 10 are respectively provided to a top face of the casing 11 of the money handling machine 10. In this case, the operation unit 45 includes numeric keys, an accept key, a start key, a clear key and a reset key, respectively provided, such that the operator can input the various commands to the control unit 15 of the money handling machine 10, by pushing such keys. For instance, the display unit 44 is composed of a liquid crystal display (LCD).

FIG. 6 specifically shows the display contents on the display unit 44. As shown in FIG. 6(a), in an initial state of the display unit 44, a number count key, a store money key, a collection by staff key, a management operation key, an exchange from large denomination to small denomination key, an exchange from small denomination to large denomination key, a depositing key and a mass depositing key are displayed on the display unit 44, respectively. The operation unit 45 serves to allow any suitable one of such keys to be selected. For instance, when the number count key is selected via the operation unit 45, the counting process that will be described later is performed in the money handling machine 10, by the operation of the clerk or the like. Alternatively, when the store money key is selected via the operation unit 45, the display on the display unit 44 is changed into a screen as shown in FIG. 6(b). Then, on the screen shown in FIG. 6(b), one of the depositing key and a dispensing key can be selected via the operation unit 45. Further, when the collection by staff key is selected via the operation unit 45, the collecting process (more specifically, a collection by staff process) that will be described later is performed in the money handling machine 10 by the person in charge of collecting the money. Alternatively, when the management operation key is selected via the operation unit 45, the money handling machine 10 will be in a management operation mode. Further, when the exchange from large denomination to small denomination key, exchange from small denomination to large denomination key, depositing key or mass depositing key is respectively selected via the operation unit 45, an exchange from large denomination to small denomination process, an exchange from small denomination to large denomination process, a depositing process or mass depositing process, as will be described later, is respectively performed in the money handling machine 10 by the clerk or the like.

In a front face of the casing 11, a printer 43 adapted for printing the process contents or the like for the money in the money handling machine 10, and a card reader 46 used for confirming or checking the authority for operating the money handling machine 10 or the like of the operator are provided respectively. In this case, the card reader 46 serves to read the ID information of the ID card carried by each operator.

Next, referring to FIG. 4, the control unit 15 adapted for controlling each component provided in the money handling machine 10 will be described. This control unit 15 is located in the casing 11 of the money handling machine 10.

As shown in FIG. 4, the control unit 15 is connected with each component of the banknote handling machine 20 (e.g., the transport unit 25, recognition unit 26, recycling banknote storing units 27, banknote stage 28, banknote holding unit 29, door 24 and the like), and is also connected with each component of the coin handling machine 30 (e.g., the coin feeding unit 33, transport unit 35, recognition unit 35a, lateral transport unit 38, recycling coin storing units 34 including the escrow unit 39 for each denomination of the coins, coin holding unit 37a and the like). Further, the control unit 15 is connected with the money storing unit 40, display unit 44, operation unit 45, printer 43 and card reader 46, and is also connected with a memory unit 47 and the like. In addition, the control unit 15 is connected with the controller 12 (17) via an interface.

This control unit 15 can serve to receive the recognition result on each banknote sent from the recognition unit 26 of the banknote handling machine 20 as well as receive the recognition result on each coin sent from the recognition unit 35a of the coin handling machine 30. Further, the control unit 15 can serve to receive information, such as the ID information of the operator or the like, inputted via the operation unit 45 or read from the ID card by the card reader 46.

In this case, for the operation of the money handling machine 10, the control unit 15 can serve to check the authority given to the operator, based on the ID information or the like of the operator inputted via the operation unit 45 or from the card reader 46. In addition, the control unit 15 can serve to control each component of the banknote handling machine 20 and coin handling machine 30, as well as control the display unit 44, printer 43 and the like.

The cash center 13 or data center 14 is provided to transmit a signal indicative of each command related to the various processes performed in the money handling machine 10, to this machine 10, via the controller 12 (17). More specifically, the cash center 13 serves to transmit the signal, related to at least one of a closing command, a delivery command, a collecting command, a depositing command, a dispensing command, a refilling command, a settlement command, an exchange from large denomination to small denomination command, an exchange from small denomination to large denomination command, a number count command, a reset command, an accept command, a start command, a lock release command and a program down load command, to the money handling machine 10.

Further, the cash center 13 or data center 14 is provided for receiving a signal indicative of information related to each process condition for the money in the money handling machine 10, from this machine 10, via the controller 12 (17). More specifically, the data center 14 serves to receive the signal, related to at least one of closing data, delivery data, collecting data, recycling-money-storing-unit money-amount data, depositing data, dispensing data, refilling data, settlement data, exchange from large denomination to small denomination data, exchange from small denomination to large denomination data, number count data, money-amount data, store money data, system data, failure data and program data, from the money handling machine 10.

In this case, the cash center 13 or data center 14 can serve to transmit and receive the signal relative to each of the banknote handling machine 20, coin handling machine 30 and money storing unit 40 of the money handling machine 10, via the controller 12 (17) and the control unit 15.

Now, the operation of the money handling machine 10 constructed as described above will be discussed.

In the operation of the money handling machine 10 as described above, there are three modes, i.e., an interface checking mode, an operation mode and a maintenance mode. The operator can select each of the interface checking mode, operation mode and maintenance mode, via the operation unit 45.

The interface checking mode is provided for checking whether or not the money handling machine 10 is connected, for communication, with a higher ranking machine or the like, via a proper interface, in the initial state of the money handling machine 10 or upon the installment of the money handling machine 10. In this interface checking mode, when the money handling machine 10 is connected, for communication, with the higher-ranking machine or the like, via the interface, various setting data will be sent to the money handling machine 10 from the higher-ranking machine or the like.

In the operation mode, there are two modes, i.e., an on-line mode in which the money handling machine 10 is connected, for communication, with the cash center 13 or data center 14, and an off-line mode in which the money handling machine 10 is not connected, for communication, with an external machine. Further, the on-line mode includes two modes, i.e., an opened store mode and a closed store mode. In the opened store mode, the operator can perform the refilling process, depositing process, dispensing process, delivery process, mass delivery process, exchange from large denomination to small denomination process, exchange from small denomination to large denomination process, reconciliation process, counting process and the like. Additionally, in this opened store mode, the collection of each cassette 41, 42 itself of the money storing unit 40 can be performed by the person in charge of collecting the money, such as the sales proceeds or the like, of the money collector. Meanwhile, in the closed store mode, only the collection of each cassette 41, 42 itself of the money storing unit 40 can be performed by the person in charge of collecting the money. It is noted that the switching operation for switching the opened store mode and closed store mode can be automatically performed in a given period of time or the like. Meanwhile, in the off-line mode, the information is not transmitted to the cash center 13, data center 14 or the like, and the result of each process, such as the depositing process or the like, is stored in the memory unit 47 of the money handling machine 10. It is noted that each of the aforementioned modes can be selected by the operator via the operation unit 45.

In the maintenance mode, a person in charge of maintenance maintains each component of the banknote handling machine 20, coin handling machine 30 and money storing unit 40 of the money handling machine 10. Such maintenance may be performed in a place where the money handling machine 10 is installed, or otherwise may be performed in a factory or the like, after the money handling machine 10 is carried back thereto.

Now, each of the refilling process, depositing process, dispensing process, delivery process, mass delivery process, exchange from large denomination to small denomination process, exchange from small denomination to large denomination process, reconciliation process, counting process, closing process, collecting process (or collection by staff process) will be described in detail. In this case, each process that will be described below is performed by controlling each component under the control of the control unit 15. Further, as will be discussed in detail, each process that will be described below is performed, when the operator inputs the various commands to the control unit 15 via the operation unit 45, or when the various commands are transmitted to the control unit 15, from the cash center 13 or data center 14, via the controller 12 (17).

### (Refilling Process)

First of all, the refilling process for the banknotes or coins will be described in brief. The refilling process for the banknotes or coins is provided for refilling each recycling banknote storing unit 27 of the banknote handling machine 20 with the banknotes for each denomination, or refilling each recycling coin storing unit 34 of the coin handling machine 30 with the coins for each denomination. Once the refilling process is performed, the amount of the money used for the refilling process, i.e., the amount of money or number for each denomination of the banknote or coins used for the refilling process, is stored, together with the date and time, ID of the operator (or operator ID) and the like, as the refilling data, in the memory unit 47. Further, the money-amount data on each money recycling unit (or money-recycling-unit money-amount data), i.e., the amount of money or number for each denomination of the banknotes or coins stored in each recycling banknote storing unit 27 or each recycling coin storing unit 34, stored in the memory unit 47 is altered, with the amount of the money used for the refilling process being added thereto.

### (Depositing Process)

Next, the depositing process for the banknotes or coins will be described in brief. This depositing process includes a mode with the delivery process and a mode without the delivery process. The depositing process in the mode with the delivery process means a mode in which the depositing process for the money is performed relative to the money handling machine 10, and then the delivery process is successively performed after the depositing process. More specifically, the banknotes are escrowed (or deposited) in the recycling banknote storing units 27, and then held in the banknote holding unit 29, and finally stored (or delivered) in the banknote storing cassette 41. In this mode, the coins are escrowed (deposited) in the escrow unit 39 for each denomination of the coins, and then held in the coin holding unit 37a, and finally stored (delivered) in the coin storing cassette 42. Thereafter, the amount of the deposited money, i.e., the amount of money or number for each denomination of the deposited banknotes or coins, is stored, together with the date and time, operator ID and the like, as the depositing data in the mode with the delivery process, in the memory unit 47. Further, the money-amount data on the money storing unit (or money-storing-unit money-amount data), i.e., the amount of money or number for each denomination of the banknotes or coins stored in the banknote storing cassette 41 or coin storing cassette 42 of the money storing unit 40, stored in the memory unit 47 is altered, with the amount of the deposited money being added thereto. Meanwhile, the depositing process in the mode without the delivery process means a mode in which only the depositing process for the money is performed relative to the money handling machine 10. After this depositing process is ended, the amount of the deposited money is stored, together with the date and time, operator ID and the like, as the depositing data in the mode without the delivery process, in the memory unit 47, and then, the money-amount data on each money recycling unit (or money-recycling-unit money-amount data) is altered, with the amount of the deposited money being added thereto. Thereafter, if the operator wants to deliver the money to the money storing unit 40, the delivery process (that will be described later) will be performed independently. It is noted that the mode with the delivery process or mode without the delivery process is set upon the installment of the money handling machine 10.

### (Dispensing Process)

Next, the dispensing process for the banknotes or coins will be described in brief. Herein, the dispensing process for the banknotes or coins is provided for dispensing the banknotes stored in each recycling banknote storing unit 27 of the banknote handling machine 20 to the exterior of the banknote handling machine 20, or dispensing the coins stored in each recycling coin storing unit 34 of the coin handling machine 30 to the exterior of the coin handling machine 30. Once the dispensing process is performed, the amount of the dispensed money, i.e., the amount of money or number for each denomination of the dispensed banknotes or coins, is stored, together with the date and time, operator ID and the like, as the depositing data in the mode with the delivery process, in the memory unit 47. Further, the money-amount data on each money recycling unit (or money-recycling-unit money-amount data) is altered, with the amount of the dispensed money being subtracted therefrom.

### (Delivery Process)

Now, the delivery process for the banknotes or coins will be described. Herein, the delivery process for the banknotes or coins is provided for delivering or feeding the banknotes stored in each recycling banknote storing unit 27 of the banknote handling machine 20 to the banknote storing cassette 41 of the banknote storing unit 40, or feeding the coins stored in each recycling coin storing unit 34 of the coin handling machine 30 to the coin storing cassette 42 of the coin storing unit 40. Once this delivery process is performed, the management authority for the banknotes or coins fed to the money storing unit 40 from each recycling banknote storing unit 27 or each recycling coin storing unit 34 is altered from the first management authority (i.e., the management authority provided on the side of the store) to the second management authority (i.e., the management authority provided on the side of the person in charge of collecting the money). In this case, the money-amount data on each money recycling unit (or money-recycling-unit money-amount data) is decreased, by the amount of the delivered money, i.e., the amount of money or number for each denomination of the delivered banknotes or coins, while the money-amount data on the money storing unit (or money-storing-unit money-amount data) is increased, by the amount of the delivered money, i.e., the amount of money or number for each denomination of the delivered banknotes or coins. At this time, the amount of the delivered money is stored, together with the date and time, operator ID and the like, as the delivery data, in the memory unit 47.

When the banknotes or coins are fed to the money storing unit 40 in the delivery process as described above, the amount of money corresponding to the amount of the delivered money will be deposited from an account of a financial institution related to the money collector into an account of another financial institution related to the store. Namely, the amount of money corresponding to the banknotes or coins, for which the management authority is shifted from the side of the store to the side of the person in charge of collecting the money, will be deposited into the account of the financial institution related to the store.

### (Mass Delivery Process)

Next, the mass delivery process for the banknotes or coins will be described in brief. Herein, the mass delivery process for the banknotes or coins is provided for delivering a great amount of banknotes into the banknote storing cassette 41 of the money storing unit 40, or delivering a great amount of coins into the coin storing cassette 42 of the money storing unit 40. Also in such a mass delivery process, as is similar to the aforementioned delivery process, the management authority for the banknotes or coins fed to the money storing unit 40 from the banknote handling machine 20 or coin handling machine 30 is altered from the first management authority (i.e., the management authority provided on the side of the store) to the second management authority (i.e., the management authority provided on the side of the person in charge of collecting the money). In this case, the amount of money corresponding to the banknotes or coins fed to the money storing unit 40 will be deposited from the account of the financial institution related to the person in charge of collecting the money into the account of the financial institution related to the store.

(Exchange from Large Denomination to Small Denomination Process and Exchange from Small Denomination to Large Denomination Process)

Next, the exchange from large denomination to small denomination process and exchange from small denomination to large denomination process, for the banknotes or coins, will be described. Herein, the exchange from large denomination to small denomination process and exchange from small denomination to large denomination process, for the banknotes or coins, are respectively provided for taking the banknotes or coins into the banknote handling machine 20 or coin handling machine 30, and then returning the banknotes or coins, which are the same in the total amount of money but different in the denomination, relative to the banknotes or coins taken in the banknote handling machine 20 or coin handling machine 30, to the exterior of the money handling machine 20 or coin handling machine 30.

### (Reconciliation Process)

Now, the reconciliation process for the banknotes or coins will be described in brief. Herein, the reconciliation process for the banknotes means a process for counting the banknotes present in the banknote handling machine 20, and then feeding the counted banknotes to the banknote reject slot 22 and checking the number or amount of money of the banknotes, and finally depositing again such checked banknotes. The reconciliation process for the coins includes two methods, i.e., a normal reconciliation method and an automatic reconciliation method. The normal reconciliation method is provided for counting the coins present in the coin handling machine 30, and then feeding the counted coins to the coin return slot 32 and checking the number or amount of money of the coins, and finally depositing again such checked coins. Meanwhile, the automatic reconciliation method is provided for feeding the coins stored in each recycling coin storing unit 34 onto the lateral transport unit 38, and feeding out the coins by using the coin feeding unit 33 and then transporting such coins by using the transport unit 35, and finally returning the coins from the escrow unit 39 for each denomination of the coins to each recycling coin storing unit 34. In this reconciliation process for the coins, the former method (i.e., the normal reconciliation method) or latter method (i.e., the automatic reconciliation method) can be optionally selected by the operator via the operation unit 45, while the operator is watching the display unit 44.

### (Counting Process)

Next, the counting process for the banknotes or coins will be described in brief. Herein, the counting process for the banknotes or coins is provided for counting the banknotes or coins present at hand. More specifically, the counting process for the banknotes is provided for feeding the banknotes into the banknote handling machine 20, escrowing (or temporarily holding) normal banknotes in the banknote holding unit 29 while feeding abnormal banknotes to the banknote reject slot 22 in order to reject such banknotes, and counting such banknotes during this escrowing or rejecting operation, and then automatically opening the door 24, for allowing the operator to take out the banknotes present in the banknote holding unit 29. Meanwhile, the counting process for the coins is provided for feeding the coins into the coin handling machine 30, and then further feeding normal coins to the lateral transport unit 38 through the overflow sorting hole 36 while feeding abnormal coins to the coin return slot 32 in order to remove such reject coins, and finally feeding the coins fed to the lateral transport unit 38 to the coin return slot 32, via the coin feeding unit 33 and transport unit 35, in order to allow the operator to take out the coins present in the coin return slot 32.

### (Closing Process)

Next, the closing process will be described in brief. When the operator inputs the closing command to the control unit 15 via the operation unit 45, or when the closing command is sent to the control unit 15 from the cash center 13 or data center 14 via the controller 12 (17), the closing data, which is the data on the number for each denomination or total amount of money or amount of money for each denomination, on the banknotes stored in the banknote storing cassette 41 and the coins stored in the coin storing cassette 42 in the delivery process, in a preset period of time, more specifically, during a period of time from the previous closing process to the current closing process, is totalized. Then, the totalized closing data is transmitted to the central control unit. The depositing process to the aforementioned account may be performed for each delivery process, or otherwise may be performed, collectively, for the delivery processes corresponding to the preset period of time, based on the closing data, upon the closing process.

### (Collecting Process (or Collection by Staff Process))

Now the collecting process (or collection by staff process) will be described. When a command for the collecting process is sent to the control unit 15, via the operation unit 45, from the person in charge of collecting the money of the money collector, the control unit 15 releases the lock of the door of the money storing unit 40, in order to allow the banknote storing cassette 41 and coin storing cassette 42 to be respectively taken out from the money storing unit 40. Thereafter, when the person in charge of collecting the money of the money collector takes out each cassette, exchanges the cassette for another empty cassette and closes the door, the collecting data, which is the data on the number for each denomination or total amount of money or amount of money for each denomination, on the collected banknotes or coins, is transmitted to the central control unit. It is noted that the details of such a collecting process will be described later.

The work for collecting the money from the money storing unit 40 of the money handling machine 10 is performed, e.g., once in every three days, in accordance with the predetermined schedule, by the person in charge of collecting the money of the money collector. However, if at least one of the banknote storing cassette 41 and coin storing cassette 42 of the money storing unit 40 is full up with the banknotes or coins delivered to the money storing unit 40 from each recycling banknote storing unit 27 or each recycling coin storing unit 34 due to the aforementioned delivery process in a period of time between a certain collecting work and the next collecting work, it becomes necessary for the person in charge of collecting the money of the money collector to perform the collecting work for collecting the money from the money storing unit 40, provisionally, for a charge, in addition to the scheduled work. However, as described above, such a special or provisional money collecting work for provisionally collecting the money from the money storing unit 40 of the money handling machine 10 is not desired for some stores or person in charge of collecting the money.

By the way, each of the processes described above, except for the delivery process in the mode with the delivery process of the depositing process, is started by performing a necessary input operation, such as by selecting a necessary process or the like, via the operation unit 45, and then pushing down the start key. Further, for the refilling process and depositing process, the process is accepted and ended, if the accept key is pushed down at a timing that can allow the clear key to be pushed down.

Otherwise, as described above, the cash center 13 or data center 14 can serve to transmit the signal, related to at least one of the closing command, delivery command, collecting command, depositing command, dispensing command, refilling command, settlement command, exchange from large denomination to small denomination command, exchange from small denomination to large denomination command, number count command, reset command, accept command, start command, lock release command and program down load command, to the money handling machine 10. Namely, in this case, such commands can be used, in place of the operation of the operation unit 45 for starting each of the aforementioned processes.

Further, the cash center 13 or data center 14 can serve to receive the signal, related to at least one of the closing data, delivery data, collecting data, recycling-money-storing-unit money-amount data, depositing data, dispensing data, refilling data, settlement data, exchange from large denomination to small denomination data, exchange from small denomination to large denomination data, number count data, money-amount data, system data, failure data and program data, from the money handling machine 10.

Thus, the information concerning the money handling machine 10 can be optionally obtained by the data center 14 or cash center 13. Therefore, the money handling system can be operated any time, even if the operator authorized to operate this money handling system is not always stationed in the store. Further, for each of the aforementioned data, the date and time on which the data was obtained and the money handling machine from which the data was obtained can be respectively clarified any time, including the date and time on which the data was obtained, store identification information and money-handling-machine identification information. In addition, the information on the date, time and manner that the money was handled in the money handling machine 10, the information on the person that related to the money handling operation, as well as the information on the money handling machine 10 that actually handled the money, can be managed more securely, by adding the data on information concerning the operator, such as the ID information or the like of the operator, date and time on which each operation was performed, to the closing data, delivery data, collecting data, depositing data, dispensing data, refilling data, settlement data, exchange from large denomination to small denomination data, exchange from small denomination to large denomination data, number count data and failure data.

In the money handling machine 10 of this embodiment, when the command for performing the collecting process is inputted to the control unit 15 by the person in charge of collecting the money of the money collector via the operation unit 45, the following operation is performed, before the control unit 15 releases the lock of the door of the money storing unit 40, in order to allow the banknote storing cassette 41 and coin storing cassette 42 to be respectively taken out from the money storing unit 40. Namely, as shown in the flow chart of FIG. 5, the control unit 15 controls each component of the money handling machine 10, so as to automatically perform the aforementioned delivery process (STEP 2) before it releases the lock of the door of the money storing unit 40, then perform the aforementioned closing process (STEP 6), and then allow the person in charge of collecting the money of the money collector to perform the collecting process (STEPs 7, 8). The check or confirmation on the authority of the operator for inputting the command for performing the collecting process to the control unit 15 is performed, for example, by reading the ID information or the like stored in the ID card carried by the person in charge of collecting the money of the money collector, or by inputting an ID number of the person in charge of collecting the money via the operation unit 45.

Now, the collecting work for the money will be described in more detail. When the command for performing the collecting process is inputted to the control unit 15 (see STEP 1 of FIG. 5), the banknotes or coins of a predetermined amount of money or number for each denomination are first automatically delivered to the money storing unit 40, from each recycling banknote storing unit 27 of the money handling machine 20 or each recycling coin storing unit 34 of the coin handling machine 30 (see STEP 2 of FIG. 5). Once this delivery process is completed, the closing data is automatically totalized, and then the totalized closing data is transmitted to the central control unit (see STEP 6 of FIG. 5). It is noted that the operation, in the case the banknote storing cassette 41 or coin storing cassette 42 of the money storing unit 40 is full up with the banknotes or coins during the delivery process, will be described later. After the closing process is ended, the control unit 15 releases the lock of the door of the money storing unit 40, in order to allow the banknote storing cassette 41 and coin storing cassette 42 to be respectively taken out from the casing 11 (see STEP 7 of FIG. 5). Thereafter, the person in charge of collecting the money of the money collector takes out the banknote storing cassette 41 or coin storing cassette 42 from the casing 11, collects the banknotes or coins, and then returns the emptied banknote storing cassette 41 or coin storing cassette 42 to the money storing unit 40, and sets again the money storing unit 40 in the casing 11. Thereafter, the person in charge of collecting the money locks again the door of the money storing unit 40 (see STEP 8 of FIG. 5). In this case, the money-storing-unit-setting detection switch SW1 detects whether or not the money storing unit 40 is set in the casing 11, and the banknote-storing-cassette-setting detection switch SW2 detects whether or not the money storing cassette 41 is set in the money storing unit 40. Further, the coin-storing-cassette-setting detection switch SW3 detects whether or not the coin storing cassette 42 is set in the money storing unit 40. As a result, once it is detected that the banknote storing cassette 41 and coin storing cassette 42 are respectively stored in the money storing unit 40, and that this money storing unit 40 is set in the casing 11, the residue detection sensor PS4 detects whether or not the banknotes are remaining on the stage 41a in the banknote storing cassette 41. If this sensor PS4 detects that there is no banknote remaining on the stage 41a in the banknote storing cassette 41, a series of operations for collecting the money are ended.

The amount of the money to be delivered and collected, i.e., the amount of money or number for each denomination of the banknotes or coins to be delivered to the money storing unit 40, with the command for performing the collecting process, is set in the control unit 15. More specifically, the amount of the money to be delivered and collected can be set by various methods. For instance, as will be described in detail below, the amount of the money to be delivered and collected can be calculated, based on the amount of the money to be left, or can be set directly, or otherwise calculated, based on the amount of free space of each storing cassette 41, 42. Further, for the amount of the money to be delivered and collected, the amount of the money to be collected can be designated, and/or large denomination money can be set to be preferentially collected when the amount of money is designated.

For instance, the amount of the money to be delivered and collected may be calculated, based on the amount of the money to be left, i.e., the amount of money or number for each denomination of the banknotes or coins to be left in each recycling banknote storing unit 27 of the money handling machine 20 or each recycling coin storing unit of the coin handling machine 30, after the delivery process is performed (or when the collecting process is performed). In this case, the amount of the money to be left may be a given value set in advance, or otherwise may be calculated, based on the money-recycling-unit money amount before the delivery process is performed (e.g., calculated as several percent (e.g., fifty percent or so) of the money-recycling-unit money amount).

Otherwise, the amount of the money to be delivered and collected may be any given suitable value that is set in advance, irrespectively of the amount of the money to be left.

Further, the amount of the money to be delivered and collected may be calculated, before the delivery process is performed, based on the amount of money or number for each denomination of the banknotes or coins taken in the casing 11 from the exterior thereof due to the aforementioned depositing process during a period of time after the previous delivery process is performed and before the current delivery process is performed (e.g., calculated as all or several percent (e.g., fifty percent or so) of the amount of money or number for each denomination of such banknotes or coins)

Otherwise, the amount of the money to be delivered and collected may be calculated, based on the total amount of the sales proceeds in the cash register 18 provided in the store (e.g., calculated as all or several percent (e.g., fifty percent or so) of the total amount of the sales proceeds).

Further, the amount of the money to be delivered and collected may be calculated, based on the money-recycling-unit money amount before the delivery process is performed (e.g., calculated as all or several percent (e.g., fifty percent or so) of the money-recycling-unit money amount).

Otherwise, the amount of the money to be delivered and collected may be calculated, based on the amount of free space of the banknote storing cassette 41 or coin storing cassette 42 of the money storing unit 40. In this case, when the command for performing the collecting process is inputted to the control unit 15, the banknotes or coins corresponding to the amount of free space of the banknote storing cassette 41 or coin storing cassette 42 of the money storing unit 40 will be delivered to the banknote storing cassette 41 or coin storing cassette 42 of the money storing unit 40, from each recycling banknote storing unit 27 of the banknote handling machine 20 or each recycling coin storing unit 34 of the coin handling machine 30. Further, in this case, the amount of free space is calculated from the difference between the whole capacity of the banknote storing cassette 41 or coin storing cassette 42 and the money-storing-unit money amount. Otherwise, the banknotes or coins can be delivered to the banknote storing cassette 41 or coin storing cassette 42 until a full-up state of each storing cassette 41, 42 is detected by the banknote full detection sensor PS2 or coin full detection sensor PS5.

As described above, the method for setting the amount of the money to be delivered and collected generally includes three approaches, i.e., (i) the method for calculating the amount of the money to be delivered and collected, based on the amount of the money to be left, (ii) the method for directly setting the amount of the money to be delivered and collected, and (iii) the method for calculating the amount of the money to be delivered and collected, based on the amount of free space of each storing cassette. However, in place of employing each method or approach individually or separately, two or three of such methods (i), (ii), (iii) may be used in a proper combination.

For instance, in the case of using the two methods (i) (ii) in a combination, the amount of the money to be delivered and collected is first set directly. Thereafter, if the amount of the money to be left becomes insufficient when the delivery process is performed, the amount of money or number for each denomination corresponding to the shortage relative to the amount of the money to be left will be subtracted from the first-set amount of the money to be delivered and collected. Further, in the case of using the two methods (i) (iii) in another combination, the amount of the money to be delivered in the delivery process or the like is first calculated, based on the amount of free space of the banknote storing cassette 41 or coin storing cassette 42 of the money storing unit 40. Thereafter, if the amount of the money to be left becomes insufficient when the delivery process is performed, the amount of money or number for each denomination corresponding to the shortage relative to the amount of the money to be left will be subtracted from the so-calculated amount of the money delivered and collected. Otherwise, in the case of using the two methods (ii) (iii) in still another combination, the amount of the money to be delivered and collected is first set directly. Thereafter, if the banknote storing cassette 41 or coin storing cassette 42 of the money storing unit 40 is full up with the money when the delivery process is performed, the amount of money or number for each denomination of the banknotes or coins that cannot be stored will be subtracted from the so-set amount of the money delivered and collected. This subtraction may be performed before the delivery process, based on the amount of free space of each cassette 41, 42, or otherwise may be performed after each cassette 41, 42 is detected to be full up with the money.

Further, if the banknote storing cassette 41 or coin storing cassette 42 of the money storing unit 40 is full up with the banknotes or coins, during the delivery process as described above, after the command for performing the collecting process is inputted to the control unit 15, the following control can be performed by the control unit 15. This control may be performed when both of the banknote storing cassette 41 and coin storing cassette 42 are full up with the money, or otherwise may be performed when either one of the two cassettes 41, 42 is full up with the money. Further, in the case one of the banknote storing cassette 41 and coin storing cassette 42 is full up with the money and the delivery process is ended before the other storing cassette is full up with the money, the following control will be performed for the storing cassette full up with the money.

Namely, when the banknote storing cassette 41 or coin storing cassette 42 of the money storing unit 40 is full up with the banknotes or coins during the delivery process (see STEPs 3, 4 of FIG. 5), the delivery process is ended (see STEP 5 of FIG. 5). Thereafter, the closing process is performed (see STEP 6 of FIG. 5). Then, the control unit 15 releases the lock of the door of the money storing unit 40 (see STEP 7 of FIG. 5), and allows the banknote storing cassette 41 and coin storing cassette 42 to be respectively taken out from the casing 11. Thereafter, the person in charge of collecting the money of the money collector takes out the banknote storing cassette 41 or coin storing cassette 42 from the casing 11, collects the banknotes or coins from each cassette 41, 42, and then returns the banknote storing cassette 41 or coin storing cassette 42 into the casing 11. Thereafter, when the door of the money storing unit 40 is locked again by this person, the series of operations for collecting the money are ended (see STEP 8 of FIG. 5).

However, another operation (or operations) than the operation described in the flow chart of FIG. 5 may be performed, when the banknote storing cassette 41 or coin storing cassette 42 of the money storing unit 40 is full up with the banknotes or coins during the delivery process. For instance, when the banknote storing cassette 41 or coin storing cassette 42 of the money storing unit 40 is full up with the banknotes or coins during the delivery process, the delivery process is interrupted, and then the closing process and collecting process are performed, respectively. Thereafter, when the emptied banknote storing cassette 41 or coin storing cassette 42 is returned into the casing 11, the delivery process may be restarted. After the restarted or second delivery process is ended, the collecting work for the money by the person in charge of collecting the money may be ended, without performing the closing process. Otherwise, when the second delivery process is ended, the closing process and collecting process may be performed again, respectively.

As described above, the condition that the banknote storing cassette 41 or coin storing cassette 42 of the money storing unit 40 is full up with the banknotes or coins can be detected by the banknote full detection sensor PS2 or coin full detection sensor PS5 provided to the banknote storing cassette 41 or coin storing cassette 42. The method for detecting whether or not the banknote storing cassette 41 or coin storing cassette 42 is full up with the banknotes or coins by the banknote full detection sensor PS2 or coin full detection sensor PS5 is performed as described above. Otherwise, whether or not the banknote storing cassette 41 or coin storing cassette 42 of the money storing unit 40 is full up with the banknotes or coins may be judged or detected, based on an additional result provided by the control unit 15 and obtained by totalizing the number of the banknotes or coins delivered, during the delivery process, to the money storing unit 40 from each recycling banknote storing unit 27 or each recycling coin storing unit 34.

As described above, according to the banknote handling machine 10 of this embodiment, as least the recycling banknote storing units 27 or recycling banknote storing units 34 are managed under the first management authority (i.e., the management authority provided on the side of the store), while the money storing unit 40 is managed under the second management authority (i.e., the management authority provided on the side of the person in charge of collecting the money) that is different from the first management authority. In this case, when the command for performing the collecting process for allowing the money to be collected from the money storing unit 40 is inputted to the control unit 15, this control unit 15 controls the banknote handling machine 20, coin handling machine 30 and money storing unit 40, so as to perform the delivery process for delivering the money stored in the recycling banknote storing units 27 or recycling coin storing units 34 to the money storing unit 40, and then perform the collecting process. In this way, since the delivery process for the money is first performed, automatically, when the command for performing the collecting process for the money is inputted to the control unit 15, this delivery process for the money can be performed, by only the operation of the money handling machine 10 performed by the person in charge of collecting the money of the money collector having the second management authority, without any need for the operation of the money handling machine 10 performed by another person, such as the clerk or the like of the store, having the first management authority. Thus, the delivery process for the money can be performed just before the collecting process for the money is performed. Therefore, the amount of the money stored in the money storing unit 40, at a point of time just before the collecting process for the money is performed, can be substantially increased. As such, the amount of the money that can be collected from this money storing unit 40 can be increased so much. Thus, the frequency of occurrence of the money collecting work can be substantially reduced.

It should be noted that the money handling machine of the present invention is not limited to one aspect as described above, and various modifications and alterations can be made thereto.

For instance, in regard to the money handling machine in the above aspect, one example, in which the management authority for managing the banknote handling machine and coin handling machine is provided on the side of the store, and the management authority for managing the money storing unit is provided on the side of the person in charge of collecting the money, has been described. However, the management authority in the money handling machine is not limited to this example. For instance, in another aspect of the money handling machine of this invention, both of the management authority for managing the recycling banknote storing units or recycling coin storing units of the banknote handling machine or coin handling machine and the management authority for managing the money storing unit may be provided on the side of a certain bank. In this case, although the collecting work for collecting the money from the money storing unit can be performed by the person in charge of collecting the money of the money collector, there is no person that is authorized to handle the money stored in the recycling banknote storing units or recycling coin storing units of the banknote handling machine or coin handling machine, on the side of the store as well as on the side of the person in charge of collecting the money. Namely, only a certain trader entrusted by the bank can handle such money stored in the recycling banknote storing units or recycling coin storing units of the banknote handling machine or coin handling machine. Further, the input operation for the delivery command for delivering the money from the recycling banknote storing units or recycling coin storing units to the banknote storing unit or the reading operation for reading the data on the money-recycling-unit money amount can be performed only by a certain person or center provided with the management authority on the side of the bank.

Further, in place of providing the storing cassettes, such as the banknote storing cassette, coin storing cassette or the like, in the money storing unit, proper storing bags, such as, a banknote storing bag, coin storing bag or the like, may be provided. Also in this case, it is preferred that various detection units are provided for respectively detecting that each banknote storing bag or coin storing bag is full up with the banknotes or coins.

Further, in place of using the money storing units, such as the cassettes, storing bags or the like, that can be respectively exchanged and carried, any other suitable money storing units respectively attached to the casing, such as fixed-type storing units or boxes, drawer-type storing units or the like, may be used. In this case, the money is transferred to each money storing unit carried by the person in charge of collecting the money.

### Second Embodiment

Next, the second embodiment of the present invention will be described. First of all, one feature achieved by this embodiment will be discussed.

In the store after the business is ended, the cash collected from each register is counted, and then the sales proceeds are calculated and accepted, by subtracting the amount of money of the change fund (or store money), i.e., a fund of the store, from the amount of money of the counted cash. Thereafter, the money related to the sales proceeds is delivered to a certain person of the money collector in charge of collecting the sales proceeds.

As disclosed in the aforementioned JP2002-312833A, the prior-art money handling machine includes the money recycling unit managed under the management authority provided on the side of the store and also used for dispensing the deposited cash, and the cassette storing unit managed under the management authority provided on the side of the person in charge of collecting the money and adapted for storing therein the cash. However, in this prior-art money handling machine, the money stored in the money recycling unit is managed collectively as one money amount. Therefore, in case in which the sales proceeds are delivered from the money recycling unit to the cassette storing unit, with the change fund being left in the money recycling unit, the money corresponding to the amount of money obtained by subtracting the amount of money of the change fund from the money amount of the money stored in the money recycling unit is delivered. Further, in this case, the sales proceeds of each register and change fund delivered to each register are deposited into the money recycling unit. However, since the money stored in the money recycling unit is managed collectively as the one money amount, the sales proceeds and store money cannot be individually totalized, at any given time, until the money of all registers is collected.

Further, a cash handling system, as disclosed in JP2002-74467A, cannot correspond to a plurality of registers. Even if the sales proceeds can be obtained or collected from the plurality of registers, the money, such as stained banknotes, deformed coins or the like, that cannot be received by the banknote handling machine or coin handling machine is managed separately from the normal money, and is hence not reflected in the money amount of the banknote handling machine or coin handling machine. Accordingly, if the sales proceeds are subtracted from this money amount, the amount of the store money is reduced, by the amount of such money that is managed separately.

Namely, since the store money managed under the management authority provided on the side of the store and the sales proceeds to be managed under the management authority provided on the side of the money collector are collectively managed as one money amount, various problems, such that the money amount of the store money cannot be managed accurately, or the like, may tend to occur.

The second embodiment of the present invention was made in view of such problems. Therefore, it is an object of this embodiment to provide the money handling machine that can manage the amount of the money stored in the recycling money storing and feeding unit, as the amount of the money of a plurality of sections. Thus, since the money can be managed, as the money of the plurality of sections, in one money handling machine, the working efficiency and accuracy of the management for the money can be securely enhanced.

Especially, in regard to the money stored in the recycling money storing and feeding unit, if the store money managed under the management authority provided on the side of the store and the sales proceeds to be managed under the management authority given to the person other than those related to the store are managed separately from each other, such store money and sales proceeds can be managed, as two items, in one money handling machine. Therefore, the money amount of the store money can be managed more accurately.

A money handling machine according to the second embodiment of the present invention includes: a casing; an inlet configured to allow the money to be put into the casing from the exterior thereof; a transport unit connected with the inlet and configured to transport the money; a money storing unit connected with the transport unit and configured to store therein the money transported by the transport unit; a recycling money storing and feeding unit connected with the transport unit and configured to store therein the money transported by the transport unit and feed the money stored therein to the transport unit; and a control unit configured to control the transport unit and recycling money storing and feeding unit to manage the amount of the money stored in the recycling money storing and feeding unit as the amount of the money of the plurality of sections.

In the money handling machine of the second embodiment, it is preferred that the control unit manages the amount of the money stored in the recycling money storing and feeding unit as the amount of the money of at least two sections, i.e., the amount of the money of a first section and the amount of the money of a second section, and that when the amount of the money stored in the recycling money storing and feeding unit is changed, the amount to be changed of the money of the first section can be inputted to the control unit, and then this amount to be changed is added or subtracted relative to the amount of the money of the first section.

Further, in the money handling machine of the second embodiment, it is preferred that the control unit manages the total amount of money, or number or amount of money for each denomination, in regard to the amount of the money.

Additionally, in the money handling machine of the second embodiment, it is preferred that the amount of the money of the second section of the amount of the money of the plurality of sections corresponds to the total amount of the money stored in the recycling money storing and feeding unit.

Otherwise, the total of the amount of the money of the plurality of sections may correspond to the total amount of the money stored in the recycling money storing and feeding unit.

Further, in the money handling machine of the second embodiment, it is preferred that the amount of the money of the second section of the amount of the money of the plurality of sections is the total amount of the money stored in the recycling money storing and feeding unit, and when the depositing process for storing the money put into the casing from the exterior thereof, in the recycling money storing and feeding unit is performed, the deposit amount, which is the amount to be changed, of the money of the first section is inputted to the control unit, and then the control unit adds the deposit amount to the amount of the money of the first section, and further adds the amount of the money stored in the recycling money storing and feeding unit in the depositing process to the amount of the money of the second section.

Otherwise, the total of the amount of the money of the plurality of sections may correspond to the total amount of the money stored in the recycling money storing and feeding unit, and when the depositing process for storing the money put into the casing from the exterior thereof, in the recycling money storing and feeding unit is performed, the deposit amount, which is the amount to be changed, of the money of the first section is inputted to the control unit, and then the control unit adds the deposit amount to the amount of the money of the first section, and further adds the amount of the money calculated by subtracting the deposit amount from the amount of the money stored in the recycling money storing and feeding unit in the depositing process, to the amount of the money of another section.

More preferably, in the money handling machine of the second embodiment, when the depositing process is performed, identification information is inputted to the control unit, and then the control unit judges the amount of the money corresponding to the identification information inputted thereto, as the deposit amount.

In the money handling machine of the second embodiment, it is preferred that when the delivery process for delivering or feeding the money from the recycling money storing and feeding unit to the money storing unit is performed, the control unit serves to feed the money corresponding to the amount of the money obtained by subtracting the amount of the money of any given section from the amount of the money stored in the recycling money storing and feeding unit, to the money storing unit.

Further, in the money handling machine of the second embodiment, it is preferred that when the dispensing process for dispensing the money stored in the recycling money storing and feeding unit to the exterior of the casing is performed, the dispense amount, which is the amount of the money to be dispensed, is inputted to the control unit, and then the control unit serves to dispense the money corresponding to the dispense amount, to the exterior of the casing, from the money stored in the recycling money storing and feeding unit, and serves to subtract the dispense amount from the amount of the money of the first section.

More preferably, in this case, when the dispensing process is performed, if the amount of the money of the first section is less than the dispense amount, the control unit will manage the amount of the money of the first section, as a negative value corresponding to the insufficient amount of the money.

Further, in the money handling machine of the second embodiment, it is preferred that the amount of the money of the first section is the amount of the money sectioned as the store money to be managed under the management authority provided on the side of the store, and that the operation unit configured to allow each necessary command to be inputted to the control unit and allow either one of the depositing key and a store-money dispensing key to be selected is further provided, and when the depositing key is selected, the control unit serves to perform the depositing process for putting the money into the casing from the exterior thereof and feeding the money put into the casing to the recycling money storing and feeding unit, and manages the money fed to the recycling money storing and feeding unit, upon this depositing process, with the section of the store money (or store money section) being separated from the section of the sales proceeds (or sales proceeds section), and when the store-money dispensing key is selected, the control unit serves to perform a store-money dispensing process for dispensing the money stored in the recycling money storing and feeding unit to the exterior of the casing, and subtracts the amount of the money dispensed to the exterior of the casing, upon this store-money dispensing process, from the amount of the money of the store money section.

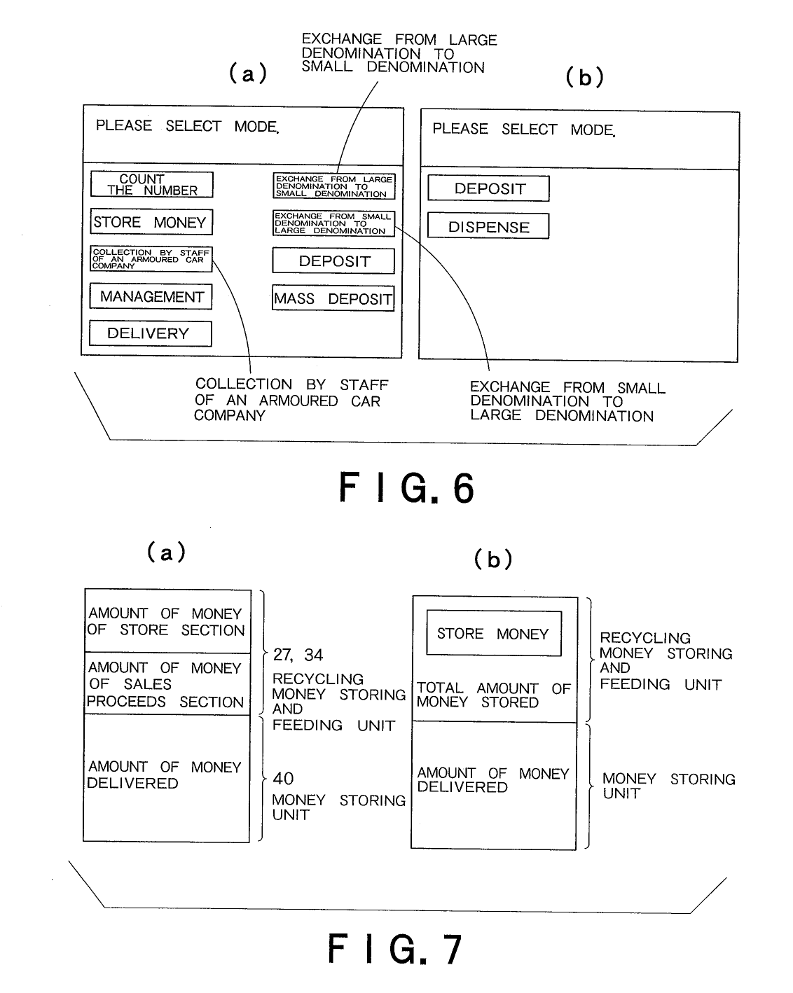

Now, referring to FIGS. 7 through 10, the money handling machine related to the second embodiment of the present invention will be described. Since the construction and operation of the money handling machine of the second embodiment are substantially the same as the construction and operation of the money handling machine of the first embodiment. Therefore, like parts in the first embodiment shown in FIGS. 1 through 6 are respectively designated by like reference numerals in the second embodiment, and further description on such parts will be omitted below.

In the money handling machine 10 related to the second embodiment, the control unit 15 serves to manage the amount of the money of the banknotes or coins stored in the recycling banknote storing units 27 or recycling coin storing units 34, as the amount of the money of the plurality of sections. More specifically, the control unit 15 serves to manage the amount of the money stored in the recycling money storing and feeding unit (hereinafter, the recycling banknote storing units 27 and recycling coin storing units 34 will be collectively referred to as the recycling money storing and feeding unit), as the amount of the money of at least two sections, e.g., the amount of the money of the first section and the amount of the money of the second section, and when the amount of the money stored in the recycling money storing and feeding unit is changed, the amount to be changed of the money of the first section can be inputted to the control unit 15, and then this amount to be changed can be added or subtracted relative to the amount of the money of the first section. In this case, the control unit 15 serves to manage the total amount of money, or number or amount for each denomination, in regard to the amount of the money. Further, in this case, the total of the amount of the money of the plurality of sections corresponds to the total amount of the banknotes or coins stored in the recycling money storing and feeding unit.

More specifically, as shown in FIG. 7(a), the control unit 15 serves to manage the store money to be managed under the management authority provided on the side of the store, separately from the sales proceeds to be managed under the management authority provided on the side of the person in charge of collecting the money, in regard to the amount of the money of the banknotes or coins stored in the recycling money storing and feeding unit. In this case, the control unit 15 serves to manage the total amount of money, or number or amount for each denomination of the banknotes or coins, in regard to the store money, as well as serves to manage the total amount of money, or number or amount for each denomination of the banknotes or coins, in regard to the sales proceeds.

More specifically, as shown in FIG. 7(a), the money amount in the money handling machine 10 corresponds to the total of the money amount of the money stored in the money storing unit 40 (i.e., the amount of the money already delivered) and the money amount of the money stored in the recycling money storing and feeding unit (i.e., the amount of the money before delivered). Further, the money amount of the money stored in the recycling money storing and feeding unit corresponds to the total of the money amount of the store money and the money amount of the sales proceeds.

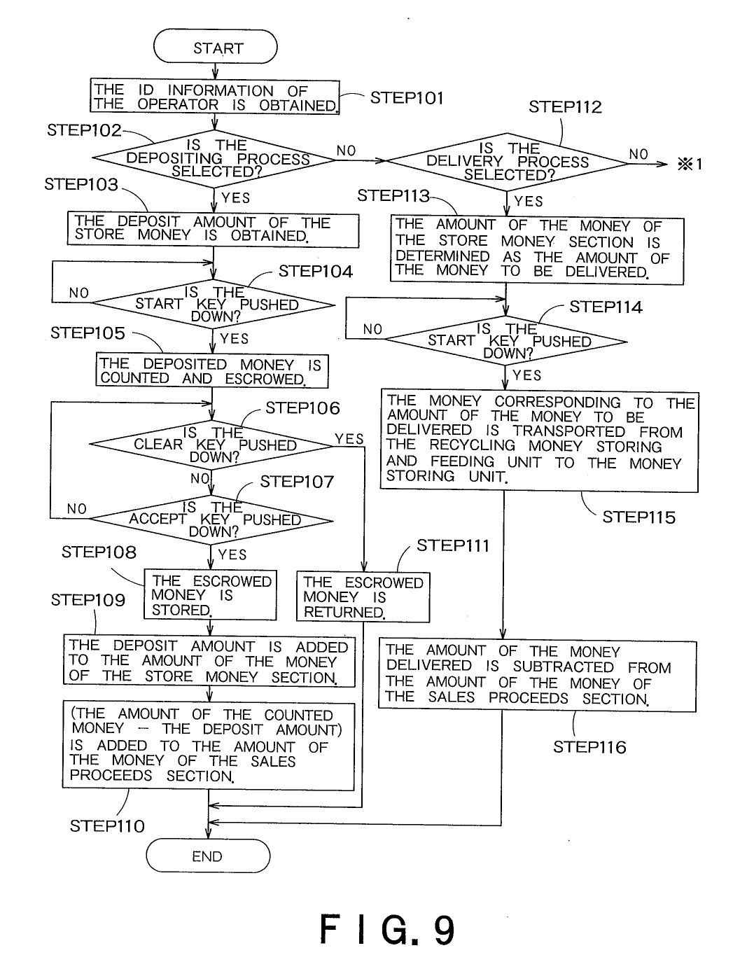

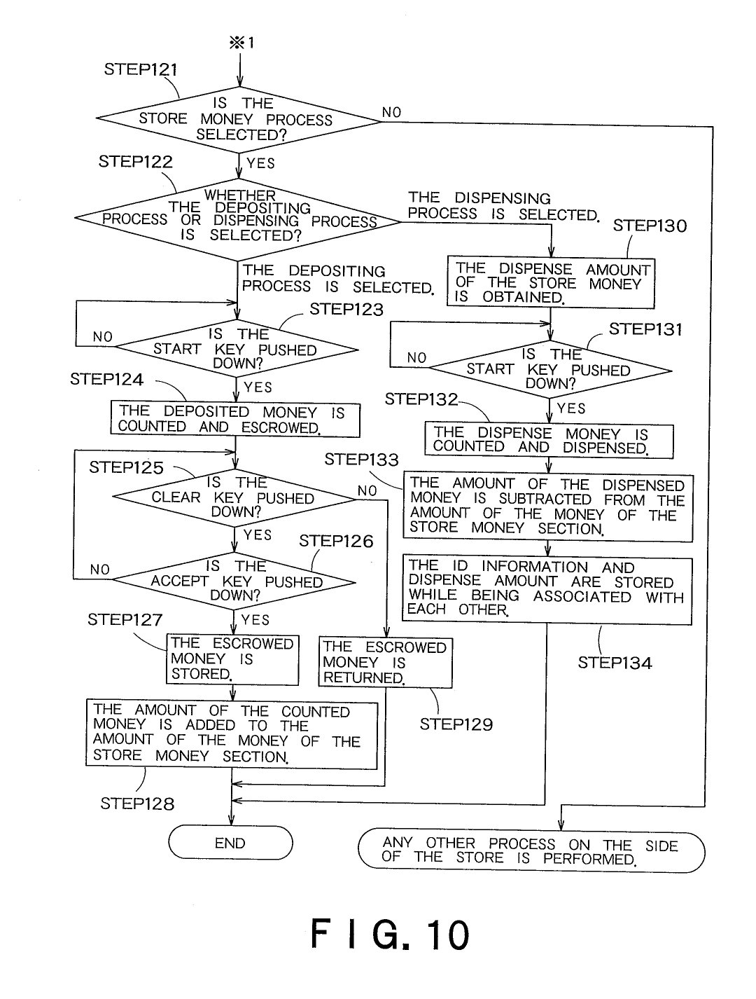

Next, referring to FIGS. 9 and 10, the operation of the money handling machine 10 of this embodiment will be described, in more detail.

First, the ID information of the operator is obtained, by reading the ID information of the ID card carried by the operator, by using the card reader 46 (STEP 101 of FIG. 9). Thereafter, when a screen of a waiting state as shown in FIG. 6(a) is displayed on the display unit 44, if the depositing key is selected in the operation unit 45, the depositing process is performed as will be described below (“YES” in STEP 102 of FIG. 9). Namely, in this depositing process, the amount of the money to be deposited (or deposit amount) of the store money is inputted to the control unit 15, by the operator, via the operation unit 45 (STEP 103 of FIG. 9).

After the money is put into the inlet, when the operator pushes down the start key (“YES” in STEP 104 of FIG. 9), the counting process for the deposited money and an escrowing process (or temporarily holding process) for the deposited money in the recycling money storing and feeding unit are performed, respectively (STEP 105 of FIG. 9). Thereafter, when the accept key is pushed down (“YES” in STEP 107 of FIG. 9), the storing process for the deposited money in the recycling money storing and feeding unit is performed (STEP 108 of FIG. 9)

At this time, the control unit 15 adds the deposit amount inputted to this control unit 15 by the operator, to the amount of the money of the store money section (STEP 109 of FIG. 9). Further, the control unit 15 adds the amount of the money obtained by subtracting the deposit amount from the amount of the money counted in the depositing process, to the amount of the money of the sales proceeds section (STEP 110 of FIG. 9). If three or more sections of the amount of the money are provided as the sections of the amount of the money stored in the recycling money storing and feeding unit in the depositing process, the amount of the money obtained by subtracting the deposit amount from the amount of the money stored in the recycling money storing and feeding unit in the depositing process may be separately added to the amount of the money of the other sections than the store money section. However, if the amount of the money is managed as the number or amount of money for each denomination of the money, the money subjected to the depositing process cannot sometimes constitute the deposit amount. In such a case, the depositing process may be performed to allow the amount of the deposited money to be greater than the deposit amount, such that this deposited money can constitute well the deposit amount. In this way, the amount of the money subjected to such a depositing process can be first added to the store money, and then the difference between the added amount of the money and the deposit amount can be subtracted from the store money.

As the deposit amount, the amount of the store money already lent to the operator, corresponding to the inputted ID information of this operator, may be inputted to the control unit 15. Herein, the store money already lent means the money dispensed from the money handling machine 10, by the clerk or the like, to be used for the change or the like in each cash register 18. Namely, in this aspect, the store money stored in the money handling machine 10 may be lent to each cash register 18.

In this case, the identification information inputted to the control unit 15 is not limited to the ID information of the operator. For instance, the identification number of each cash register 18, ID information of another person in charge of operating the machine than the operator, or the like may be inputted, as the identification information, to the control unit 15. Also in this case, any given amount of money corresponding to such inputted identification information can be inputted, as the deposit amount, to the control unit 15.

After the operator pushes down the start key (“YES” in the STEP 104 of FIG. 9), and then the counting process for the deposited money and the escrowing process (or temporarily holding process) for the deposited money in the recycling money storing and feeding unit are performed (STEP 105 of FIG. 9), if the operator does not push down the accept key, but pushes down the clear key (“YES” in STEP 106 of FIG. 9), the deposited money escrowed or temporarily held in the recycling money storing and feeding unit is returned to the exterior of the casing 11 (STEP 111 of FIG. 9).

Further, if the recycling money storing and feeding unit is full up with the money during the depositing process as described above, the control unit 15 serves to feed a part or all of the money, except for the money corresponding to the store money of the number or amount for each denomination, among the banknotes or coins stored in the recycling money storing and feeding unit, to the money storing unit 40. With this operation, the money corresponding to the store money will be left in the recycling money storing and feeding unit.

Next, the delivery process will be described. Namely, when the screen of the waiting state as shown in FIG. 6(a) is displayed on the display unit 44, if the delivery key is selected in the operation unit 45, the delivery process is performed as will be described below (“YES” in STEP 112 of FIG. 9).

Namely, in this delivery process, the amount of the money of the sales proceeds section is determined as the amount of the money to be delivered (STEP 113 of FIG. 9). Otherwise, the amount of the money obtained by subtracting the store money from the amount of the money of the banknotes or coins stored in the recycling money storing and feeding unit may be determined as the amount of the money to be delivered.

Thereafter, when the operator pushes down the start key (“YES” in STEP 114 of FIG. 9), the control unit 15 serves to feed the money corresponding to the amount of the money to be delivered, among the money stored in the recycling money storing and feeding unit, to the money storing unit 40 (STEP 115 of FIG. 9). With this operation, the money corresponding to the store money stored in the money handling machine at a point of time of this delivery process is left in the recycling money storing and feeding unit. Then, the control unit 15 subtracts the amount of the money to be delivered from the amount of the money of the sales proceeds section (STEP 116 of FIG. 9). During this delivery process, if at least one of the banknote storing cassette 41 and coin storing cassette 42 in the money storing unit 40 is full up with the money, the delivery process for delivering the money to such a cassette that is full up with the money will be stopped (the state or condition of the cassette full up with the money is detected by the sensor for detecting the amount of the banknotes or coins stored in the cassette or detected by the number of the banknotes or coins stored in the cassette).

Further, when the screen of the waiting state as shown in FIG. 6(a) is displayed on the display unit 44, if the store money key is selected in the operation unit 45, the store money process is performed as will be described below (“YES” in STEP 121 of FIG. 10). Namely, when the store money key is selected, the display on the display unit 44 is changed into the screen as shown in FIG. 6(b). If the store money process is not selected (“NO” in the STEP 121 of FIG. 10), any other process on the side of the store is performed.

Further, if the operator selects the depositing key on the screen of the display unit 44 as shown in FIG. 6(b) (i.e., THE DEPOSITING PROCESS IS SELECTED.” in STEP 122 of FIG. 10), the depositing process is performed as will be described below. More specifically, when the operator selects the depositing key and then pushes down the start key (“YES” in STEP 123 of FIG. 10), the counting process for the deposited money put into the inlet and the escrowing process (or temporarily holding process) for the deposited money in the recycling money storing and feeding unit are performed, respectively (STEP 124 of FIG. 10). Thereafter, when the accept key is pushed down (“YES” in STEP 126 of FIG. 10), the storing process for the deposited money in the recycling money storing and feeding unit is performed (STEP 127 of FIG. 10). At this time, the control unit 15 adds the amount of the money of the deposited and counted money to the amount of the money of the sales proceeds section (STEP 128 of FIG. 10). In this case, if at least one of the recycling banknote storing units 27 and recycling coin storing units 34 are full up with the money during the escrowing process, the escrowing process in the at least one of the recycling banknote storing units 27 and recycling coin storing units 34 full up with the money is stopped, and the money put into the machine will be returned.

After the operator pushes down the start key (“YES” in the STEP 123 of FIG. 10), and then the counting process for the deposited money and the escrowing process (or temporarily holding process) for the deposited money in the recycling money storing and feeding unit are performed (STEP 124 of FIG. 10), when the operator does not push down the accept key, but pushes down the clear key (“YES” in STEP 125 of FIG. 10), the deposited money escrowed or temporarily held in the recycling money storing and feeding unit is returned to the exterior of the casing 11 (STEP 129 of FIG. 10).

Meanwhile, if the operator pushes down the dispensing key on the screen of the display unit 44 as shown in FIG. 6(b) (i.e., THE DISPENSING PROCESS IS SELECTED.” in the STEP 122 of FIG. 10), the dispensing process is performed as will be described below. More specifically, when the dispensing process is performed, the amount of the money to be dispensed (or dispense amount) is inputted to the control unit 15, by the operator, via the operation unit 45 (STEP 130 of FIG. 10). Thereafter, when the operator pushes down the start key (“YES” in STEP 131 of FIG. 10), the control unit 15 serves to dispense the banknotes or coins corresponding to the dispense amount, among the banknotes and coins stored in the recycling money storing and feeding unit, to the exterior of the casing 11 (STEP 132 of FIG. 10). Further, the control unit 15 subtracts the amount of the dispensed money from the amount of the money of the store money section (STEP 133 of FIG. 10). In this case, if the amount of the money of the store money section is less than the amount of the dispensed money, the control unit will manage the store money, as a negative value corresponding to the insufficient amount of the money. Further, the control unit 15 stores the dispense amount in the memory unit 47, while this dispense amount is associated with the ID information of the operator read by the card reader 46 (STEP 134 of FIG. 10).

When the dispensing process is performed as described above, the ID information read by the card reader 46 may be inputted to the control unit 15, and a predetermined amount of the money corresponding to the inputted ID information of the operator may be regarded as the dispense amount in the control unit 15.

As described above, according to the money handling machine 10 of this embodiment, the control unit 15 serves to manage the amount of the money of the banknotes or coins stored in the recycling money storing and feeding unit (or recycling banknote storing units 27 or recycling coin storing units 34), as the amount of the money of the plurality of sections. Namely, by managing the amount of the money of the banknotes or coins stored in the recycling money storing and feeding unit, as the amount of the money of the plurality of sections, the money of such a plurality of sections can be managed by one money handling machine 10. Therefore, the working efficiency and accuracy of the management for the money can be highly enhanced.

More specifically, the control unit 15 can serve to manage the amount of the money stored in the recycling money storing and feeding unit, as the amount of the money of the at least two sections, i.e., the amount of the money of the first section (e.g., the store money to be managed under the management authority provided on the side of the store) and the amount of the money of the second section (e.g., the sales proceeds to be managed under the management authority provided to another person than those related to the store (e.g., the management authority provided on the side of the person in charge of collecting the money)). In this case, when the amount of the money stored in the recycling money storing and feeding unit is changed, the amount to be changed of the money of the first section can be inputted to the control unit 15, and then this amount to be changed is added or subtracted relative to the amount of the money of the first section. For instance, in the case the store money to be managed under the management authority provided on the side of the store is managed separately from the sales proceeds to be managed under the management authority provided to another person than those related to the store, in regard to the banknote or coins stored in the recycling money storing and feeding unit, such store money and sales proceeds can be managed, as the two items, in one money handling machine 10. Therefore, the money amount of the store money can be managed more accurately. Further, the control unit 15 can serve to manage the amount of the money, as the total amount of money of the banknotes or coins, or as the number or amount of money for each denomination of the banknotes or coins. In this case, the total of the amount of the money of the plurality of sections corresponds to the total amount of money of the banknotes or coins stored in the recycling money storing and feeding unit.

It should be noted that the money handling machine of the present invention is not limited to the preferred examples as described above, and various modifications and alterations can be made thereto.

For instance, in the case of managing the amount of the money of the banknotes or coins stored in the recycling money storing and feeding unit, as the amount of the money of the plurality of sections, the store money may be managed separately from the total amount of the money stored in the storing unit, as shown in FIG. 7(b), in place of managing the store money separately from the sales proceeds, as shown in FIG. 7(a). As used herein, the total amount of the money stored in the storing unit means the total amount of the banknotes or coins stored in the recycling money storing and feeding unit.

In the case of managing the amount of the money of the banknotes or coins stored in the recycling money storing and feeding unit, with the store money being managed separately from the total amount of the money stored in the storing unit, when the depositing process in the mode without the delivery process is performed, the deposit amount of the store money is inputted to the control unit 15 by the operator via the operation unit 45 before this depositing process is performed, and then the control unit 15 adds the inputted deposit amount to the store money. Thereafter, the control unit 15 adds the amount of the money stored in the recycling money storing and feeding unit in this depositing process to the total amount of the money stored in the storing unit.

While all of the keys provided are displayed in the display unit 44, by way of example, on the LCD or the like as shown in FIG. 6(a), the manner of displaying such keys is not limited to this example.

Namely, in the case of displaying all of the keys by using the LCD or the like as shown in FIG. 6(a), it may be sometimes difficult for the operator to clearly distinguish some keys allowed to be actually used or performed, from the other keys not allowed to be used, because of the condition of the money amount in the money handling machine 10, authority given to the operator or the like. Therefore, it is preferred that the keys not allowed to be used or performed because of the condition of the money amount in the money handling machine 10 or the like are turned off, respectively. Otherwise, it is preferred that all of the keys are turned off until the authority of the operator is confirmed, and then only the keys respectively allowed to be operated by the operator will be turned on after the authority is confirmed.

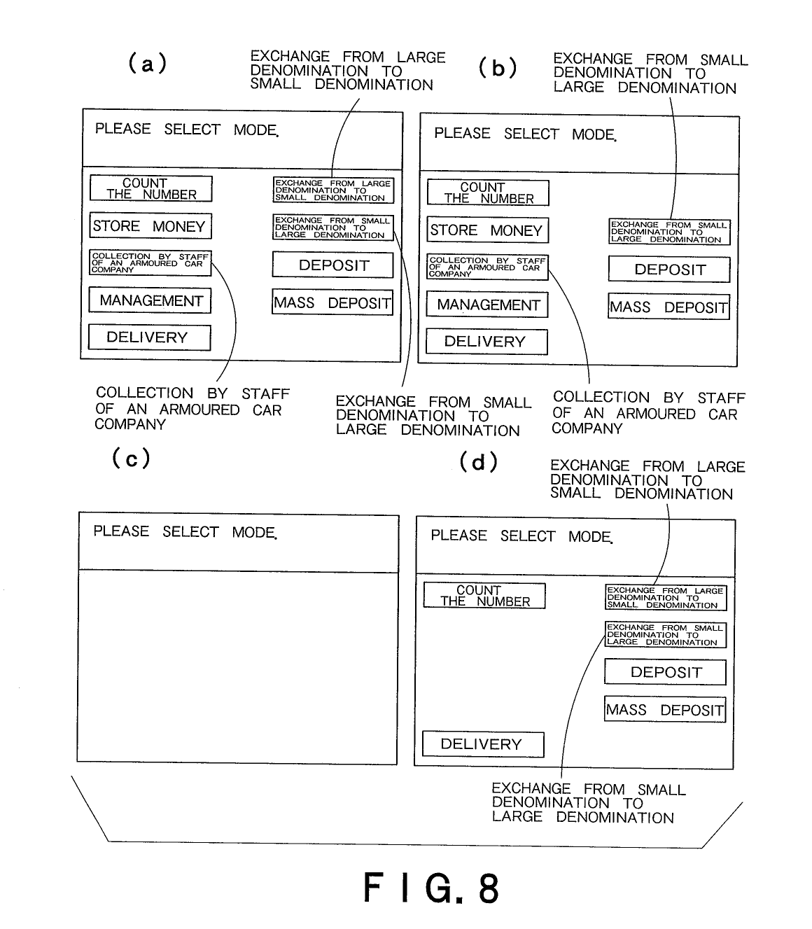

Now, referring to FIG. 8, the display of the respective keys will be described in more detail. For instance, in the case a sufficient amount of the banknotes or coins are stored in the recycling money storing and feeding unit of the money handling machine 10, all of the keys are displayed on the display unit 44, as shown in FIG. 8(a). Meanwhile, in the case there are not enough banknotes or coins stored in the recycling money storing and feeding unit, and hence a money change process (e.g., the exchange from small denomination to large denomination process or the like) cannot be performed, a money change key (e.g., the exchange from small denomination to large denomination key or the like) is turned off on the display unit 44, as shown in FIG. 8(b).

Alternatively, all of the keys may be turned off in the display on the display unit 44, as shown in FIG. 8(c), until the authority of the operator is confirmed. In this case, once the authority of the operator is confirmed, such as by reading the ID information of the ID card carried by the operator, by using the card reader 46, the keys respectively allowed to be operated by the operator are displayed, as shown in FIG. 8(d). It is noted that the keys displayed on the display unit 44 as shown in FIG. 8 (d) designates the display contents provided for the operator, e.g., the clerk or the like, on the side of the store.

Further, not only for occurrence of some too-late event but also for occurrence of some too-early event, in the depositing process, exchange from small denomination to large denomination process, exchange from large denomination to small denomination process, dispensing process, delivery process, closing process or collection by staff process, the time may be corrected, based on the time fixed in each response message sent from the cash center 13 or data center 14. Namely, in the prior-art money handling machine, the time is corrected for only the too-late event in the collection by staff process. Meanwhile, for the too-early event, the time is corrected, manually, upon the maintenance for the money handling machine. However, according to this invention, the time can be corrected, based on the time fixed in each response message sent from the cash center 13 or data center 14, not only for the occurrence of the too-late event but also for the occurrence of the too-early event. As such, the time correcting operations can be performed many times, for one day, with a short time interval. Therefore, more appropriate time correction can be provided even in the case of occurrence of the too-early event.

1. A money handling machine configured to handle money, comprising:
a casing;
an inlet configured to allow the money to be put into the casing from the exterior thereof;
a transport unit connected with the inlet and configured to transport the money;
a money storing unit connected with the transport unit and configured to store therein the transported money;
a recycling money storing and feeding unit connected with the transport unit and configured to store therein the transported money and feed out the stored money to the transport unit; and
a control unit configured to control the transport unit, the money storing unit and the recycling money storing and feeding unit,
wherein at least the recycling money storing and feeding unit is managed under a first management authority and the money storing unit is managed under a second management authority different from the first management authority, and
when a command for performing a collecting process for allowing the money to be collected from the money storing unit is inputted to the control unit, the control unit controls the money storing unit, the transport unit and the recycling money storing and feeding unit, so as to perform a delivery process for delivering the money stored in the recycling money storing and feeding unit to the money storing unit, and then perform the collecting process.

2. The money handling machine according to claim 1, wherein the amount of the money to be delivered is set by the control unit, the amount of the money to be delivered being the amount of money or the number of money by denomination to be delivered from the recycling money storing and feeding unit to the money storing unit during the delivery process.

3. The money handling machine according to claim 2, wherein the control unit calculates the amount of the money to be delivered, based on the amount of the money to be left, the amount of the money to be left being the amount of the money or the number of the money by denomination to be left in the recycling money storing and feeding unit after the delivery process is performed.

4. The money handling machine according to claim 3, wherein the amount of the money to be left is a given value that is set in advance.

5. The money handling machine according to claim 3, wherein the amount of the money to be left is calculated, based on the amount of the money stored in the recycling money storing and feeding unit before the delivery process is performed.

6. The money handling machine according to claim 2, wherein the amount of the money to be delivered is a given value that is set in advance.

7. The money handling machine according to claim 2, wherein the amount of the money to be delivered is calculated, based on the amount of money or the number of the money by denomination taken into the casing from the exterior thereof after the previous delivery process is performed and before the current delivery process is performed.

8. The money handling machine according to claim 2, wherein the amount of the money to be delivered is calculated, based on the amount of the money stored in the recycling money storing and feeding unit before the delivery process is performed.

9. The money handling machine according to claim 2, wherein the amount of the money to be delivered is calculated, based on the capacity of the money storing unit to store the money.

10. The money handling machine according to claim 2, wherein the amount of the money to be delivered is calculated, based on a denomination that is designated in advance and the money amount of this denomination.

11. The money handling machine according to claim 2, wherein the amount of the money to be delivered is set, with the large denomination having priority.

12. The money handling machine according to claim 1, wherein when the money storing unit is full up with the money during the delivery process, the control unit terminates the delivery process and performs the collecting process.

13. The money handling machine according to claim 1, wherein when the money storing unit is full up with the money during the delivery process, the control unit suspends the delivery process and performs the collecting process, and then performs again the delivery process after the collecting process.
